(19) United States
(12) Patent Application Publication
(10) Pub. No.: US 2022/0189647 A1
(43) Pub. Date: Jun. 16, 2022

(54) Direct Nuclear Power Conversion

(71) Applicant: Beam Alpha, Inc., West Chicago, IL (US)

(72) Inventor: Gerald Peter Jackson, Lisle, IL (US)

(73) Assignee: Beam Alpha, Inc., West Chicago, IL (US)

(21) Appl. No.: 17/433,924

(22) PCT Filed: Feb. 24, 2020
(86) PCT No.: PCT/US20/19449

§ 371 Date: Aug. 25, 2021

Related U.S. Application Data
(60) Provisional application No. 62/811,485, filed on Feb. 27, 2019.

(51) Int. Cl. G21B 1/19; G21B 1/17; H02K 7/00; H02K 7/18

(52) U.S. Cl. CPC G21B 1/19; H02K 7/1823; H02K 7/003; G21B 1/17

(57) ABSTRACT

Articles of manufacture, machines, processes for using the articles and machines, processes for making the articles and machines, and products produced by the process of making, along with necessary intermediates, directed to direct nuclear power conversion.

### PRIORITY

This application claims the benefit of U.S. Provisional Patent Application No. 62/811,485, Titled: “Direct Nuclear Power Conversion,” filed Feb. 27, 2019. This U.S. Provisional Patent Application No. 62/811,485 is hereby incorporated by reference in its entirety as if fully restated herein.

### BACKGROUND

Fusion is generally defined as the process by which lighter nuclei are merged to form heavier nuclei. For lighter nuclei the fusion process liberates energy in the form of kinetic energy in the residual particles. The vast majority of past attempts at generating electrical power from fusion reactions have contemplated boiling water to drive conventional turbines (an example of a means approximated by a Carnot cycle). These past attempts have often utilized strong magnetic fields to constrain plasmas of electrons and ions until the ions collide and fuse. Such magnetic containment is prone to instabilities and particle leakage, causing inadvertent and often catastrophic loss of energy that would otherwise be needed to sustain fusion reactions.

The electrons within the plasma present their own set of difficulties. First, because electrons are much lighter than ions, electromagnetic collisions between electrons and ions tend to rob the ions of the kinetic energy needed for the fusion process. Second, these scattered electrons tend to be relativistic, emitting photonic radiation when the collide or accelerate. This photonic radiation is also a large source of energy leakage, robbing the plasma of the energy needed to sustain fusion reactions.

There is a class of fusion reactions referred to as aneutronic. In these reactions very little of the energy liberated by the reactions is in the form of kinetic energy in neutrons. Neutrons pose several problems when contemplating widespread application of fusion-based electrical power generation. First, the way that their kinetic energy is converted into electrical power is through their absorption in material in the form of heat. Second, neutrons pose a significant radiological risk to nearby personnel and are very difficult to shield. Third, large doses of neutrons in metals cause embrittlement and dimensional changes, compromising the functionality and integrity of the reactor.

Accordingly, there is a need for improvement over such past approaches.

### SUMMARY

The disclosure below uses different prophetic embodiments to teach the broader principles with respect to articles of manufacture, apparatuses, processes for using the articles and apparatuses, processes for making the articles and apparatuses, and products produced by the process of making, along with necessary intermediates, directed to direct nuclear power conversion. This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

References sited herein are incorporated by reference as if fully stated herein. The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider an apparatus (method of making, method of using) including generator of output electrical power constructed so as to produce more of said output electrical power than electrical power input to the apparatus, e.g., by bringing into collision two species of ions so as to induce fusion reactions. In some embodiments herein, the generator: (1) can be devoid of a magnetic field that constrains a plasma; (2) can be such that energy released from the fusion reactions is not converted into said output electrical power by a by a process approximated by a Carnot cycle; (3) or can be both. Illustratively, consider several channels to teach the broader concepts of producing such electrical power. As teaching illustrations, one channel uses the aneutronic reaction of boron-hydrogen fusion, and another channel uses the aneutronic reaction of lithium-hydrogen. For such embodiments, in both cases beryllium-8 nuclei are briefly formed, wherein that nucleus immediately decays into two energetic helium-4 nuclei (otherwise known as alpha particles). Note that the formation of beryllium-8 with the symmetric production of two energetic and charged alpha particles is of interest because the alpha particles are charged, and thus their motion represents an electrical current. Similar to the use of electron motion in vacuum tubes to create amplifiers for early radios and televisions, the motion of these alpha particles can be converted directly into electrical power without an intermediate step of creating steam and driving a turbine, as in a means for approximating a Carnot cycle.

### INDUSTRIAL APPLICABILITY

Industrial applicability is representatively directed to that of apparatuses and devices, articles of manufacture—particularly electrical—and processes of making and using them. Industrial applicability also includes industries engaged in the foregoing, as well as industries operating in cooperation therewith, depending on the implementation.

### DRAWINGS

In the non-limiting examples of the present disclosure, please consider the following:

FIG. 1 is an illustration of an embodiment of an electrical generator [002] directly harvesting electrical energy from fusion reactions;

FIG. 2 is an illustration of one embodiment of an electrostatic ion accelerator [006] used to collide a beam of boron ions [028] with a beam of hydrogen ions/protons [026];

FIG. 3 is an illustration of a plot of mesh transparency T(□) as a function of angle □ for several choices of equatorial opacity L₀;

FIG. 4 is an illustration of a logarithmic plot of average opacity <L> as a function of equatorial opacity L₀, and the dashed line is the displayed power law fit to the data (solid line) calculated using (C.7);

FIG. 5 is an illustration of a plot of the measured kinetic energy spectrum of alpha particles emitted by collisions of protons on stationary boron-11 atoms;

FIG. 6 is an illustration of a plot of the alpha particle electrical current impinging upon the spherical vacuum vessel as a function of central region [014] electrostatic potential;

FIG. 7 is an illustration of a generator [002] embodiment where the electrostatic potential at the central region [014] is −524 kV;

FIG. 8 is an illustration of a circuit model of the generator [002] embodiment wherein the central electrostatic potential is −524 kV;

FIG. 9 is an illustration of an embodiment of the vacuum maintenance system of the electrical power generator [002];

FIG. 10 is an illustration of a plot of the gross output electrical power [082] by a negative particle conduit [022] as in FIG. 8 (solid curve) and the net power after subtracting power consumed [020] by alpha particle absorption on the inner mesh electrode [008] (dashed curve);

FIG. 11 is an illustration of a circuit model of the generator [002] embodiment wherein the central electrostatic potential is −1600 kV;

FIG. 12 is an illustration of a plot of the fusion cross section for a proton projectile striking a stationary boron-11 nucleus;

FIG. 13 is an illustration of a plot of the calculated energy loss for a proton (hydrogen ion) projectile incident on a stationary slab of solid boron;

FIG. 14 is an illustration of a typical center-of-momentum collision between two particles of different mass and charge;

FIG. 15 is an exaggerated illustration (not to scale) of the embodiment of the outer mesh electrode [010] as a proton and low-energy alpha particle sweeping system;

FIG. 16 is an illustration of the outer mesh electrode [010] sweeping system with differential sweeping voltages and electric fields indicated;

FIG. 17 is an illustration of one embodiment of the location of conduit [022] of output electrical power [082] to the outside of the generator [002];

FIG. 18 is an illustration of an electrical power transmission embodiment using accelerated negatively charged particles [064] to convert water into steam;

FIG. 19 is an illustration of an electrical power transmission embodiment using accelerated negatively charged particles [064] to generate high frequency electrical power [104] and output electrical power [082];

FIG. 20 is an illustration of an electrical power transmission embodiment using mechanical motion to directly generate alternating current output electrical power [082];

FIG. 21 is an illustration of an electrical power transmission embodiment using photons [142] to transfer energy to the exterior of the generator [002];

FIG. 22 is an illustration of an electrical power transmission embodiment using magnetic flux within an insulating ferrite core [184] to transfer energy to the exterior of the generator [002];

FIG. 23 is an illustration of a graph of the measured secondary electron yield due to bombardment of metal surfaces by protons;

FIG. 24 is an illustration of a graph of the measured secondary electron yield due to bombardment of metal surfaces by protons (open triangles) and helium ions (open circles)

FIG. 25 is an illustration of a graph of the measured secondary electron yield due to bombardment of a molybdenum surface by singly ionized atomic and molecular nitrogen;

FIG. 26 is an illustration of an apparatus for measuring the secondary electron kinetic energy spectrum;

FIG. 27 is an illustration of a graph of the measured secondary electron kinetic energy spectrum due to bombardment of a metal surface by ions;

FIG. 28 is an illustration of a graph of the measured secondary electron yield due to bombardment of metal surfaces by relativistic electrons;

FIG. 29 is an illustration of a graph of the measured secondary electron kinetic energy spectrum due to bombardment of metal surfaces by relativistic electrons; and

FIG. 30 is an illustration of an electrical power transmission embodiment using hydraulic fluid flow to directly generate alternating current output electrical power [082].

### DETAILED DISCLOSURE OF MODES

The following detailed description is directed to concepts and technologies for direct nuclear power conversion into electrical power by fusion reactions, teaching by way of prophetic illustration. The disclosure includes an apparatus comprising a generator of output electrical power in a construction to bring into collision two species of ions so as to induce nuclear fusion reactions and thereby produce more of said output electrical power than electrical power input to the apparatus. Similarly, the following disclosure teaches a method of generating electrical power, the method comprising generating more output electrical power than electrical power input to an apparatus by bringing into collision, in said apparatus, two species of ions so as to induce nuclear fusion reactions. These are indicative of how to make such an apparatus as well as necessary intermediates produced in the methods.

In contrast to past attempts at nuclear fusion for the purposes of electrical power generation, this disclosure teaches an apparatus wherein the generator of output electrical power can be devoid of a magnetic field that contains a plasma comprised of said ions brought into said collisions. It also describes a method of bringing ions into collision in ways that can be devoid of constraining a plasma with a magnetic field.

Also in contrast to past attempts at nuclear fusion, this disclosure describes an apparatus wherein energy released from the nuclear fusion reactions need not converted into said output electrical power by a means approximated by a Carnot cycle. Similarly, this disclosure teaches a method wherein the generating is carried out devoid of converting energy released from the nuclear fusion reactions into said output electrical power by a means approximated by a Carnot cycle.

Boron-Hydrogen Fusion

One teaching embodiment for teaching broader concepts is directed to boron-hydrogen fusion, a reaction in which no neutrons are generated (an aneutronic reaction), in stark contrast to other types of neutronic fusion reactions, such as deuterium-tritium reactions. Boron-hydrogen fusion is employed herein as a prophetic teaching, recognizing that materials other than boron and hydrogen can be fused consistent with the prophetic teaching by this example.

One embodiment for net electrical power generation utilizing fusion is to induce fusion events by colliding a beam of protons [026] (bare hydrogen nuclei) with a beam of bare, or fully-stripped, boron-11 nuclei [028]. Bare nuclei are atoms that have had all of their orbiting electrons stripped away, that is to say, consisting essentially of no electrons. The absence of energetic neutrons emanating from the reactions avoids a major source of radioactivity induced safety and material control issues.

Specifically, this disclosure teaches an apparatus wherein the two species of ions are brought into said collision as two particle beams [026] and [028] comprising a first ion beam [027] and a second ion beam [029], one species per beam, both beams consisting essentially of no electrons. This disclosure also teaches a method wherein the bringing into collision comprises bringing into collision two species of ions as two particle beams [027] and [029], one species per beam, both particle beams consisting essentially of no electrons.

When boron-11 and protons fuse, two high-energy alpha particles (bare helium nuclei) are generated. When these alpha particles are formed in the vicinity of the central region [014] (illustrated initially in FIG. 2) of a negative electrostatic potential that is, for example, spherical in shape, their trajectory away from the central region [014] toward progressively more positive electrostatic potential causes the initial alpha kinetic energy to be converted into electrostatic potential energy (a current flowing into a repelling voltage). In other words, the positively charged alpha particles flow (electrical current) into a positive terminal (voltage) to generate stored power (e.g., charge a battery). There is no need to generate heat and then boil water to spin turbines. Consider direct electrical power production having innate conversion efficiencies as high as 80%. The next section discusses one embodiment to implement direct electrical power production from hydrogen-boron fusion.

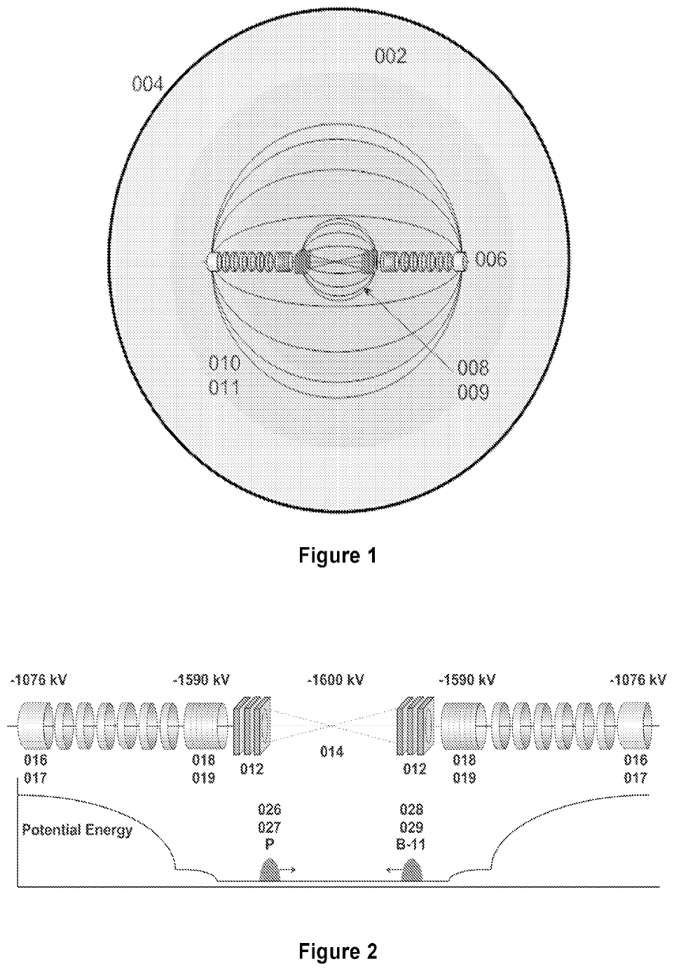

FIG. 1 illustrates an embodiment of a generator [002]. An ion accelerator [006] is suspended inside a spherical vacuum vessel wall [004] wherein a radial electric field is established by electrostatically charging the two spherical wire-mesh electrodes [008] and [010]. In this embodiment the generator includes a first spherical mesh electrode [011] concentric with said spherical vacuum vessel, connected to a source of said first ion beam [017] (illustrated initially in FIG. 2 and found in several subsequent Figures), and a second spherical mesh electrode [009] concentric with said spherical vacuum vessel, connected to a source of said second ion beam [019] via an intermediate power supply [020] (illustrated initially in FIG. 8 and found in several subsequent Figures). The optimum kinetic energies of the two beams at the central region [014] are 48 keV for the boron-11 nuclei [028] and 524 keV for the protons [026]. The mean kinetic energy of the high-energy alpha particles is 4000 keV. But because the alpha particles have an electrical charge of two protons, a radial voltage difference of 2000 kV is sufficient to convert this kinetic energy into electrostatic potential energy (stored electrical power).

Other embodiments of the vacuum vessel wall [004] and the two mesh electrodes [008] and [010] exist wherein these structures are not spherical. These structures together, or each individually, might be cylindrical, toroidal, or even rectangular. The benefit of spherical shapes is that the alpha particles reach the vacuum vessel wall [004] with a uniform reduction in kinetic energy. In the other shapes the alpha particle deceleration is no longer independent of angle emanating from the central region [014] resulting in a lack of conversion efficiency to output electrical power [082] (first illustrated in FIG. 18 and found in several subsequent Figures). Within the disclosure spherical is defined as essentially spherical, wherein deviation from a theoretically pure sphere is tolerable as long as the reduction in conversion efficiency from alpha particle kinetic energy to electrical power production is within tolerable limits.

An ion accelerator [006] embodiment that satisfies the above boundary conditions is illustrated in FIG. 2, comprising a first ion beam comprised of hydrogen [027] and a second ion beam comprised of boron-11 [029]. The electrostatic accelerator [006] is structured to direct said first ion beam [027] to repeatedly collide with said second ion beam [029] in a central region [014] of said vacuum vessel, whereby said first ion beam [027] and said second ion beam [029] are brought into collision via collisions. The generator [002], using the ion accelerator [006], is configured to produce said first ion beam [027] with an average kinetic energy greater than or equal to an average kinetic energy of said second ion beam [029] during said collisions, said first ion beam [027] with an average momentum equal to an average momentum of said second ion beam [029] during said collisions, and said first [027] and second ion [029] beams with a combined kinetic energy sufficient to induce said nuclear fusion reactions when ions within each beam experience the collisions;

Similarly, FIG. 2 indicates a method wherein a forming of a first ion beam [027] includes forming of the first ion beam [027] comprising hydrogen and forming of a second ion beam [029] is carried out comprising boron-11. This method including electrostatically accelerating, within said spherical volume, said first ion beam [027] to repeatedly collide with said second ion beam [029] in a central region [014] of said spherical volume to produce collisions, wherein said first ion beam [027] has an average kinetic energy greater than or equal to an average kinetic energy of said second ion beam [029] during said collisions, said first ion beam [027] has an average momentum equal to an average momentum of said second ion beam [029] during said collisions, and said first [027] and second [029] ion beams have a combined kinetic energy sufficient to induce nuclear fusion reactions when individual particles within each beam experience said collisions. One embodiment entails a method of generating including forming a first ion beam [027] of said ion beams within the volume and forming a second ion beam [029] of said ion beams within the volume, the ion beams consisting essentially of no electrons.

Because bare boron nuclei have an electrical charge of five protons, a potential well depth of 10 kV is sufficient to cause them to oscillate back and forth across the central region [014] coinciding with the beam focal point in the central region [014]. The central electrostatic potential (voltage) is −1600 kV in order to partially decelerate the alpha particles that will emanate from the central region [014]. In order to cause the protons to also oscillate back and forth across the same central region [014], a potential well depth of at least 524 kV is indicated. When protons reach the end electrodes, which are the location of the proton sources [016], the protons have maximum potential energy and zero kinetic energy (they stop and reverse course). In the central region [014] the protons (and boron nuclei) have minimum potential energy and maximum kinetic energy.

In one embodiment, a prophetic teaching, an idealized electrical generator has a continuous gross electrical output power [082] of 2 kW (enough to power a large home without air conditioning) with a duration of 10 years without refueling. Per hydrogen-boron fusion event, two high-energy alpha particles deposit four proton charges at a voltage of 1600 kV. Assuming perfect conversion efficiency, an output power of 2 kW indicates a fusion rate of 2×10¹⁶ events per second. The average proton current consumed in this rate of fusion is 313 microAmperes, and the average boron ion current is 5× higher, or 1.56 mA. In terms of mass, boron is consumed at a rate of 1.1 grams per year, or 11 grams over the assumed 10-year duration of the generator [002].

Continuing the description of this embodiment, the 11 grams of boron and approximately 1 gram of hydrogen are stored in their source locations [016] and [018]. The boron source [018] locations are at −1590 kV in FIG. 2 directly outside of the central region [014]. Hereafter the term “boron source” is used to describe a source of boron-11 nuclei wherein essentially all electrons have been stripped from the original neutral boron atoms. As described in Section F, electrons have a deleterious effect on generator performance. Therefore hereafter the term “essentially all electrons have been stripped” indicates a situation wherein no electrons are desired but a small fraction of electrons may remain within the ion beam so long as those remaining electrons do not significantly decrease the output electrical power [082] of the generator [002]. One embodiment teaches a generator [002] wherein electrons, propagating within said vacuum, do not deflect said ions or change ions' kinetic energies. Another embodiment entails a method of generating wherein said regulating does not include reducing said combined kinetic energy, so as to affect said regulating, with electrons propagating within said wall [004]

For each fully-stripped boron ion generated, these boron sources [018] charge up by five electrons. In the case of hydrogen, the proton source [016] locations are at −1076 kV in FIG. 2. For each proton generated, these proton sources [016] charge up by one electron. If allowed to accumulate, the voltage of these sources will change, and the accelerator will cease to function as intended. Constant source voltages within the ion accelerator [006] happens through the controlled bleeding of these remaining electrons back to the alpha particles on the vacuum vessel wall [004], thereby forming neutral helium atoms again within the vacuum vessel wall [004]. The motion (bleeding) of these excess electrons toward more positive voltages creates the output electrical power [082].

For each fusion event six free electrons are generated. But the two high-energy alpha particles account for 4 of those electrons. In a hydrogen-boron fusion embodiment there is a third low-energy alpha particle that is generated. If nothing is done with this third alpha, there would an additional accumulation of alpha particles oscillating around in the generator [002]. The fate of these low-energy alpha particles is addressed below.

Electrical Power Generation

One embodiment of the electrical generator [002] is illustrated in FIG. 1. Note that a basic concept for such embodiments is to suspend the ion accelerator [006] in FIG. 2 within a spherical vacuum vessel wall [004] held at zero electrostatic potential (grounded). Note that a pair of mesh spherical electrodes [008] and [010] connect the focusing optics [012] at −1600 kV and the proton sources [016] at −1076 kV. Ignoring infrequent collisions with the accelerator structure or the mesh electrodes, this geometry ensures that high-energy alpha particles reach the vacuum vessel at reduced kinetic energy.

At this point in the discussion, the problem with FIG. 1 is that there still is no mechanism for removing the electrons building up in the boron sources [018] at −1590 kV and the proton sources [016] at −1476 kV. But FIG. 1 does contain a solution for the trapped low-energy alpha particles. The solution lies in the nature of the opacity of the spherical mesh grids attached to the proton sources [016] and indirectly to the boron sources [018].

Spherical Mesh Opacity

In an embodiment the mesh electrodes [008] and [010] (also labelled as [009] and [010] herein) are comprised of a number of wires N of a specified diameter d. Assume that the wire grid has a mean spherical radius R. The wire mesh is comprised of a set of wires arranged as lines of longitude on a globe. Let □ be a polar angle where the equator is defined as □=0. At the equator the opacity L₀ of the wire-mesh, defined as the probability of a single alpha particle striking a wire in a single pass, is described by the equation

$${L}_{0} = \frac{N d}{2 π R} \qquad ( C .1 )$$

Note that total equatorial opacity L₀=1 occurs when the wire diameter times the number of wires is equal to the sphere equatorial circumference.

The more general form L(□) is derived by writing down the circumference as a function of latitude, or more precisely as a function of □. From trigonometry, the latitude radius of the sphere R(□) at a given angle is

R(θ)=R cos(θ) (C.2)

Accordingly, the general form of (C.1) is

$$L ( θ ) = \frac{{L}_{0}}{cos ( θ )} \qquad ( C .3 )$$

Note that there is some critical angle □₀ at which the sphere becomes opaque for all greater angles. By definition, at the poles the sphere is always opaque. This critical angle is described by the equation

$${θ}_{0} = a cos ( \frac{N d}{2 π R} ) = a cos ( {L}_{0} ) . \qquad ( C .4 )$$

The quantity needed next is the average opacity. The transparency T(□) of the mesh, defined as the probability of NOT striking a wire,

$$T ( θ ) = 1 - \frac{{L}_{0}}{cos ( θ )} , \qquad ( C .5 )$$

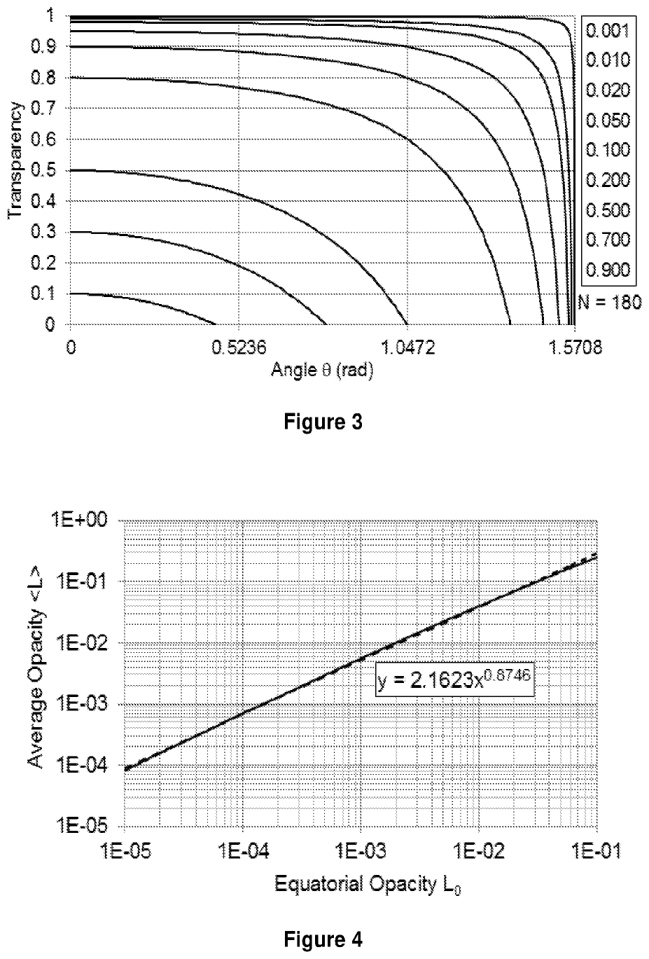

is an easier quantity to work with to calculate averages and trends. Transparency is plotted in FIG. 3 as a function of angle □ for several values of equatorial opacity L₀. In the figure the equatorial opacity of 0.001 corresponds to the upper curve and equatorial opacity of 0.900 corresponds to the lowest curve nearest the lower-left corner. The average transparency <T> of the mesh over all angles is calculated by performing the integral

$$〈 T 〉 = \frac{2}{π} {\int }_{0}^{{θ}_{0}} T ( θ ) d θ , \qquad ( C .6 )$$

Substituting (C.5) into (C.6) and performing the integral yields the result

$$〈 T 〉 = \frac{2}{π} \{ {θ}_{0} - {L}_{0 } Ln \vert tan ( \frac{{θ}_{0}}{2} + \frac{π}{4} ) \vert \} , \qquad ( C .7 )$$

FIG. 4 shows the average opacity <L>=1−<T> as a function of equatorial opacity L₀. Note that over a wide range of values the two quantities are related closely by a power law. The solid line is the calculated relationship (C.7) while the dashed line is the power law fit to those values.

So a low-energy alpha particle emanating from the central region [014] of FIG. 1 cannot reach the walls of the spherical vacuum vessel to be absorbed there. Instead, the low-energy alpha particle will oscillate back and forth through the central region [014] until the low-energy alpha particle eventually strikes a wire. For an average opacity of 1%, the average particle would make 25 oscillations through one mesh or 12.5 oscillations through two meshes before striking a wire and being absorbed.

In one embodiment, said first spherical mesh electrode [011] is configured to have a higher opacity to ions emanating from said collisions than said second spherical mesh electrode [009].

Alpha Particle Absorption

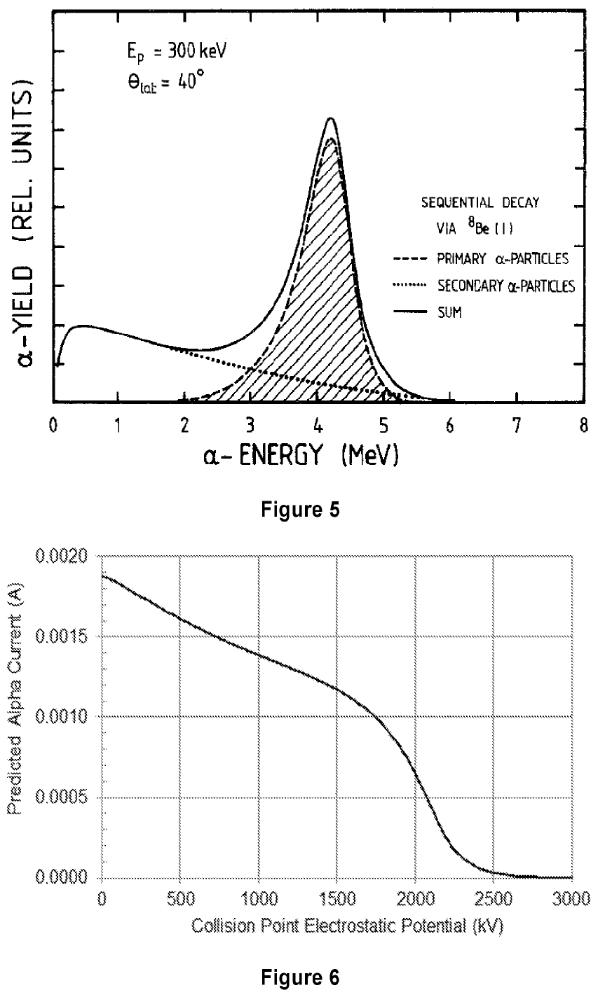

The measured kinetic energy spectrum of the alpha particles generated by hydrogen-boron fusion is shown in FIG. 5. Note that the two high-energy alpha particles occupy the peak at 4 MeV, and the low-energy alpha particles form the shoulder which peaks near 1 MeV. Applying this spectrum to the embodiment in FIG. 1, and varying the electrostatic potential at the central region [014], the electrical current of alpha particles striking the vacuum vessel wall [004] can be calculated. If the central electrostatic potential exceeds 3 MV, according to FIG. 5 there should be no measured current on the vacuum vessel wall [004], since no alpha particle will have sufficient kinetic energy to reach that radius. At zero central voltage all alpha particles (assuming total transparency of the two mesh spheres) will register as current. FIG. 6 shows this relationship between alpha particle current and central voltage assuming a combined average boron [028] and proton [026] input current of 1.87 mA (corresponding to the simplistic calculation of 2 kW continuous output electrical power [082] in Section A).

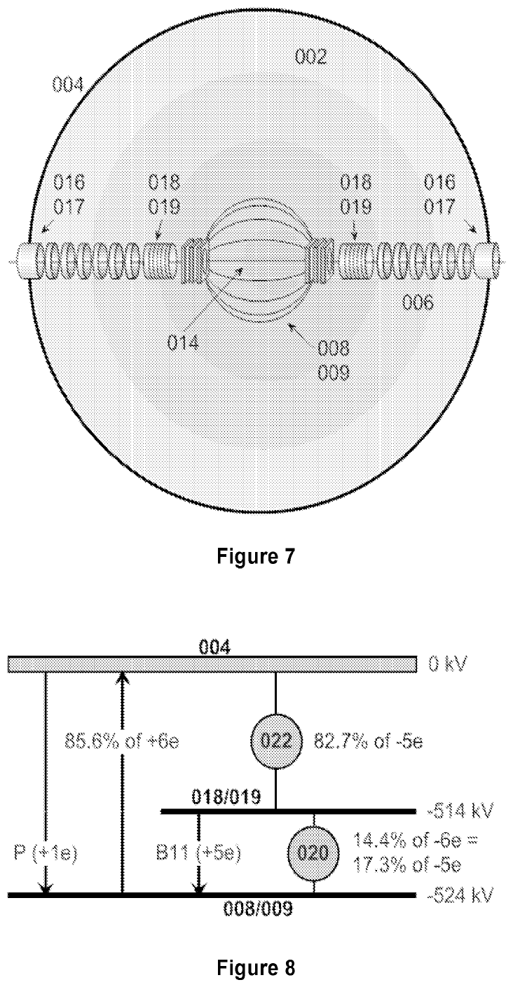

It is instructive to study a generator [002] embodiment where the central voltage at the central region [014] is reduced to −524 kV. At this voltage the outer mesh electrode [010] in FIG. 1 merges with the vacuum vessel wall [004], creating the geometry shown in FIG. 7. In this case the outer mesh electrode [010] is eliminated and the architecture of the generator [002] simplifies.

According to the data behind FIG. 6, 14.4% of the alpha particles cannot reach the vacuum vessel wall [004] and 85.6% of the alpha particles register as electrical current. A circuit model of this embodiment is shown in FIG. 8. The leftmost line shows the single proton per fusion event leaving the proton sources [016] now at the vacuum vessel wall [004] and travelling to the central region [014] which is at the potential of the inner mesh electrode [008]. The next line to the right shows the 85.6% of the alpha particle charge arriving back at the vacuum vessel wall [004]. The next line over indicates the boron-11 nuclear current per fusion leaving the boron source [018]. Because the voltages throughout the generator are constant with respect to time, the inner mesh electrode [008] and the boron source [018] see zero net electrical current. The power supply [020] sends a stream of electrons into the inner mesh electrode [008] to account for low-energy alpha particle absorption in the electrode wires. The number of electrons per fusion event is the above 14.4% of alpha particle current, which is equivalent to 17.3% of the five electrons liberated in the boron source [018] for each fusion event, and by driving electrons toward an electrode [008] more electrically negative, this power supply consumes electrical power created by fusion.

The generator [002] is the actual generator of output electrical power [082]. Similar to water flowing from a mountain reservoir to generate electricity, these electrons flowing toward a more positive electrode will generate electrical power. The net electrical power generated by the system is the difference between the power sourced in the generator [022] minus the power consumed by the inner mesh power supply [020]. Per fusion, the sourced power is proportional to 0.827×5×514=2125, whereas the consumed power is proportional to 0.173×5×10=8.7. Therefore, in this generator embodiment the absorption of the low-energy alpha particles lowers the output power of the generator by 0.4%.

Throughout this section the alpha particles have been said to be absorbed. At residual kinetic energies when striking metal surfaces, alpha particles penetrate a short depth into the metal. Once they stop (due to collision with electrons in the metal), the alpha particles each pick up two electrons to become neutral helium atoms. Eventually this helium gas diffuses out of the metal into the vacuum within the generator vacuum vessel wall [004]. After bouncing around for a while, the helium gas is eventually pumped out of the vacuum vessel wall [004] via ports [040] connected to vacuum pumps [044].

A form of vacuum pumping relies on ion (or ion-sputter) pumps [044]. Every pumped helium atom represents a current of one electron into 5 kV. Therefore, per fusion, the pump will consume electrical power proportional to 3×5=15. Therefore, in this embodiment the net output power of the generator is depressed by (8.7+15)/2125 or 1.1%.

Hence, in one embodiment the generator [002] includes at least one ion sputter vacuum pump [044] and a spherical vacuum vessel containing a vacuum and comprising a vacuum vessel central region [014] and a vacuum vessel wall [004]. In one embodiment of a generator [002] said ions are brought into said collisions in a vacuum maintained by one or more ion-sputter pumps [044]. Another embodiment is a method of generating electrical power, including evacuating a spherical volume [002], having a vacuum vessel wall [004], to produce a vacuum sufficient to enable storage of said ion beams, wherein said evacuating includes evacuating with an ion sputter vacuum pump [044].

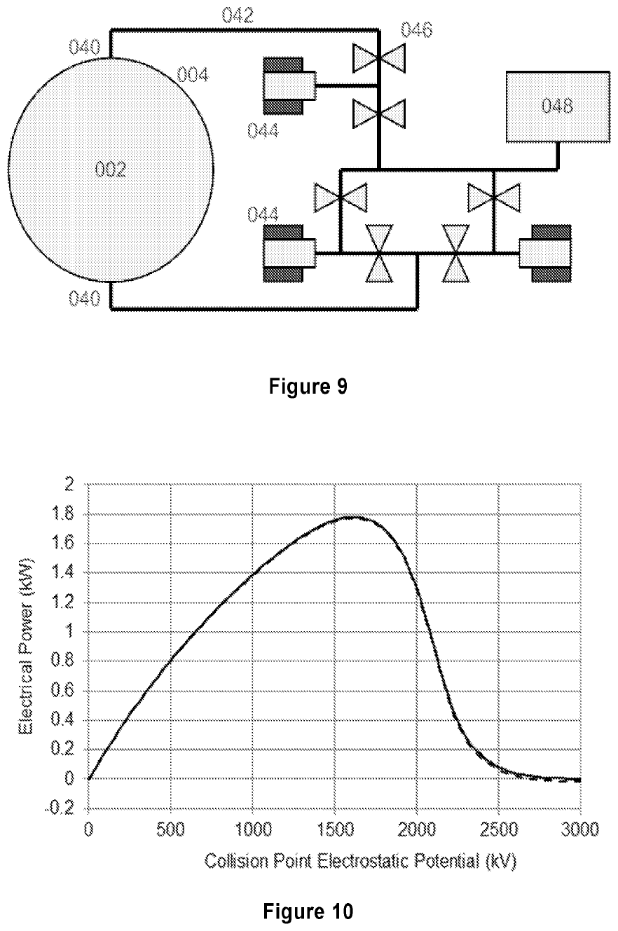

Ion pumps [044] cannot pump helium indefinitely. Eventually the helium saturates the titanium getter plates and outgasses at a rate comparable to the pumping rate. In order to overcome this limitation, each ion pump [044] is arranged to be isolated from the fusion generator vacuum vessel by vacuum valves [046]. When these valves are closed, the Penning cell magnets around the ion pump chamber are removed and the pump [044] chamber is heated. Another valve [046] is opened which allows the outgassing helium to be removed via a roughing pump [048]. This roughing pump [048] can be a mechanical pump (such as a turbomolectular pump) or a cryogenic trap. This embodiment of the vacuum maintenance system of the generator is illustrated in FIG. 9.

Electrical Generation Embodiments

In an embodiment where the opacity of the inner mesh electrode [008] of FIG. 1 is much higher (significantly less transparent) than the outer mesh electrode [010], the associated discussion concerning the power supply illustrated in FIG. 8 is generally preserved. Assuming no alpha particle electrical current into the outer mesh electrode [010], the gross generator output power and net output power (not accounting for vacuum pumping) are displayed in FIG. 10. The solid curve shows the output electrical power [082] generated by electron transport to the vacuum vessel wall [004] (generator [022] in FIG. 8). Note that this peak power is reduced from the earlier simplistic design of 2 kW down to 1.8 kW. This reduction is due to the fact that the alpha particle kinetic energy spectrum is not monoenergetic. This peak power occurs at the central region [014] electrostatic potential of −1600 kV assumed in FIG. 2.

The dashed curve in FIG. 10, which is generally indistinguishable from the solid curve, showing the net power of the fusion generator when the power consumed by the inner mesh electrode [008] absorbing lower-energy alpha particles is accounted for. The net power diverges from the gross power at the upper end of the inner mesh electrode [008] voltage range, where the net power actually goes negative. When very few alpha particles are able to reach the vacuum vessel wall [004] and register as electrical current, almost all of the alpha particles end up absorbed by the inner mesh sphere. In this situation the consumed power exceeds the gross power output, and fusion generator [002] is no longer operating above the breakeven criterion.

Representing one electrical generator embodiment, the central region [014] electrostatic potential is set at this optimum voltage of −1600 kV. Similar to the earlier embodiment presented in Section D, 14.4% of the alpha particles do not have sufficient energy to reach the outer mesh electrode [010] and are absorbed by the inner mesh electrode [008].

According to the data behind FIG. 6, at the central voltage of −1600 kV approximately 40% of the alpha particles have insufficient kinetic energy to reach the vacuum vessel wall [004]. This means that 40−14.4=25.6% of the alpha current can be absorbed by both the inner [008] and outer [010] mesh electrodes. The curve in FIG. 10 represents an embodiment where the inner mesh electrode [008] is much more opaque than the outer mesh electrode [010].

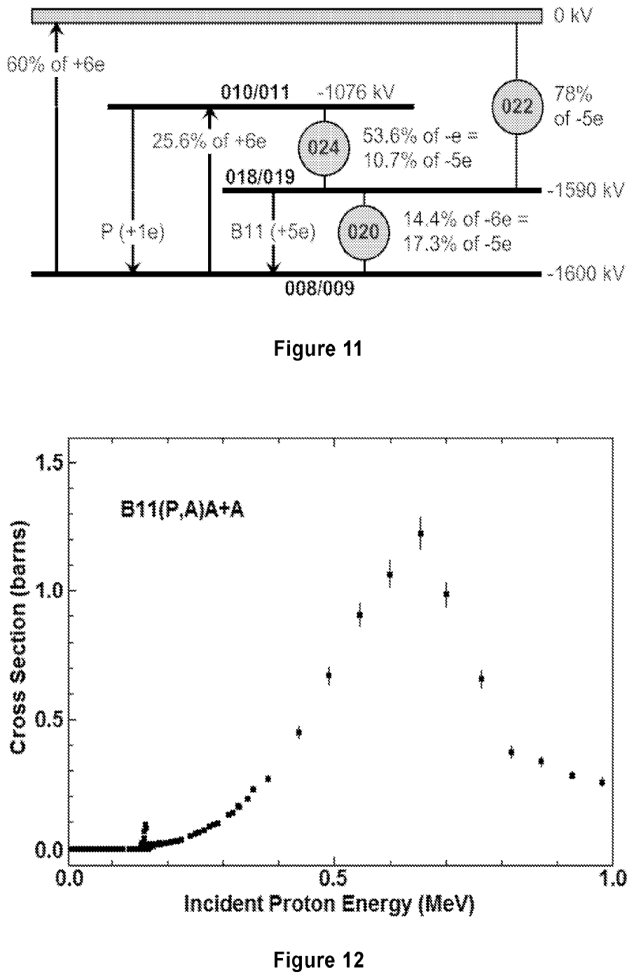

In another generator embodiment the outer mesh electrode [010] is much more opaque that the inner mesh electrode [008]. FIG. 11 contains a circuit diagram of this embodiment. FIG. 11 is very similar to FIG. 8 in many respects. The second and fourth lines from the left are the same proton [026] and boron-11 [028] beams emanating from their respective sources [016] and [018]. The leftmost line shows the 60% of all alpha particles that have sufficient kinetic energy to be absorbed by the vacuum vessel wall [004]. The third line from the left represents the 25.6% of the alpha particles that are now absorbed by the outer mesh electrode [010]. The inner mesh power supply [020] is the same as in FIG. 8 with the same compensating electron current (number of electrons per fusion event).

The big difference is the outer mesh generator [024] between the boron source [018] and outer mesh electrode [010]. Because the outer mesh electrode [010] remains at a constant voltage of −1076 kV, no net charges flow into the mesh electrode [010] and connected proton source [016]. On average, for every fusion event there is a corresponding proton emission and an absorption of 25.6% of the six resulting alpha particle charges. In one embodiment, electrons are transported from the boron-11 source [018] to the more positive outer mesh electrode [010], generating electrical power. The compensating current is equivalent to 10.7% of the electron charge stripped from the emitted boron-11 nucleus.

The conclusion is that there is a net electron emission from the boron-11 beam source [018] to the outer vacuum vessel wall [004], equivalent to 78% of the electron charge stripped from the boron-11 nucleus. Again, because these electrons are flowing from a negative to relatively positive electrode, electrical power generation [082] takes place. Per fusion, the gross power output of this rightmost generator is proportional to 0.78×5×1590=6201. The gross power output of the middle generator is proportional to 0.107×5×514=275. The consumed power in the yellow generator is proportional to 0.173×5×10=8.7. Therefore, in this embodiment the absorption of the low-energy alpha particles actually increases the output power of the generator by 0.2%. Again, similar to the situation in FIG. 10, the difference between the gross power production and the net power is negligibly small near the optimum operating point of −1600 kV.

Center-of-Momentum Frame Coulomb Scattering

The measured cross section, or probability, for a proton striking a stationary boron-11 atom to undergo a fusion reaction is shown in FIG. 12. The peak of the cross section occurs at a proton kinetic energy of 0.65 MeV, with the FWHM width of that peak approximately 0.25 MeV.

Cross section has units of area, with one barn equal to an area of 1×10⁻²⁸ m². In the case of this reaction, consider a single high-energy alpha particle. Since each fusion reaction liberates two such high-energy alpha particles, the peak cross fusion section is actually half of the value shown in FIG. 12. Illustratively, the value of 0.6 barns is used in prophetic teachings herein.

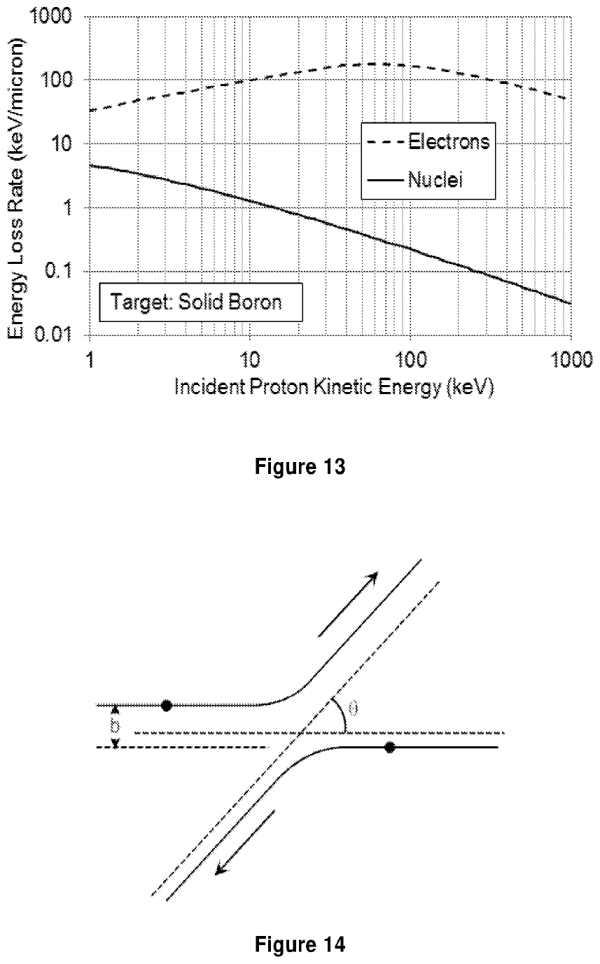

When an ion beam traverses any material, the ions within the beam lose kinetic energy as they move. The rate of energy loss is determined by the elements of which the material is comprised and the energy of the incident ions. There are two dominant causes of this energy loss. Above kinetic energies of approximately 0.1 keV the energy loss is dominated by scattering off the electrons orbiting the atomic nuclei. Below this energy scattering against the nuclei themselves generates energy loss comparable or larger than electrons. FIG. 13 shows the calculated energy loss for a proton (hydrogen ion) beam incident on a slab of solid boron. The upper dashed line is the rate of kinetic energy loss for a typical metallic boron target. The lower solid line would be the rate of energy loss if all electrons were removed from a theoretical boron target, wherein only Coulomb scattering off the nuclei themselves were the cause of the energy loss.

The peak of the cross section curve in FIG. 12 corresponds to an incident proton kinetic energy of 650 keV in FIG. 13, which is near the right edge of the plot. At this energy the electron collisions have a 2000× greater impact on beam deceleration than the corresponding boron nuclei in the target. In a standard laboratory setting where the boron target is electrically neutral the deceleration caused by the electrons in the target is so fast that a proton has little chance to induce a fusion reaction before the proton loses so much energy that the proton kinetic energy is below the peak in FIG. 12, and fusion is no longer probable. Therefore, in certain embodiments taught herein, electrons can be removed from the target by various mechanisms. One mechanism for accomplishing this result, albeit at much lower density than a slab of boron metal, is to suspend fully stripped boron-11 nuclei with electromagnetic fields inside a vacuum vessel.

When a box 1 m in all three dimensions holds a single boron-11 target nucleus, the probability P of a single proton projectile striking that single target nucleus and initiating a fusion event is simply the cross section of the reaction (0.6 barns=0.6×10⁻²⁸ m²) divided by 1 m², or P=0.19×10⁻²⁸. A boron target has a density of 2.35 g/cm³ which corresponds to a number density of 1.3×10²⁹ nuclei/m³. For a slab that is 1 m×1 m in size but only 1 mm thick in the direction of the beam, there are 1.3×10²⁶ nuclei/m³. The probability of inducing fusion within this slab is then 0.77%.

At proton kinetic energies near the cross section peak in FIG. 12 the calculated energy losses in FIG. 13 in this slab are 70 MeV/mm due to the electrons orbiting the boron nuclei and 0.049 MeV/mm due to the boron nuclei themselves. Since the cross section peak in FIG. 12 has a width of 0.25 MeV, a proton with an incident kinetic energy above the peak would decelerate to a point below the peak in at a slab depth of 0.25/70=0.0036 mm. The probability of fusion is negligibly small, certainly too small to attain breakeven energy production when the energy to accelerate the protons is accounted for.

If all of the electrons were theoretically removed from the slab, the depth into the slab at which the proton energy would decelerate across the cross section peak is 0.25/0.049=5.1 mm. This corresponds to an average rate of fusion per proton of approximately 3.9%. In the embodiment in which the central region [014] electrostatic potential was −1600 kV, the average energy generation per fusion is approximately 2 alpha particles time 2 charges per alpha particle times 1600 kV or 6400 keV. Per proton, the average recoverable energy is therefore 3.9% of 6400 keV, or 250 keV. But since 650 keV had to be invested in that proton to get the proton up to the indicated kinetic energy, theoretical breakeven electrical energy production is still not possible.

So far in this Section the discussion has assumed a “fixed target” or laboratory frame of reference in which a projectile nucleus collides with a stationary target nucleus. In one embodiment of a fusion-driven electrical generator [002] the proton [026] and boron-11 [028] beams have equal and opposite linear momenta at the central region [014] in FIG. 2. Their collisions are then said to occur in the center-of-momentum frame, which is illustrated in FIG. 14. There are repercussions to operations in this frame.

First, particles in the two beams [026] and [028] that happen to make close approaches and scatter electrostatically against one another do not change their kinetic energy. This eliminates the above fixed target energy loss of projectile nuclei penetrating stationary targets.

The second repercussion is that both particles leave the central region [014] with the same deflection angle. The fusion events which are the goal of this generator are exceedingly rare, with roughly 1 in a million protons (or boron-11 nuclei) undergoing fusion each pass between the beams. However, large angle scattering events such as in FIG. 14 occur with about the same probability.

This means that there are just as many boron nuclei and protons traversing the space in and around the mesh spheres as alpha particles. The oscillations of the boron nuclei and protons across the central region of the spherical vacuum wall occur just the same as the alpha particles, and the opacities of the mesh spheres are the same for these beam particles as they are for the alpha particles.

In the case of alpha particles, their absorption into the mesh spheres converts them into gaseous helium that is pumped out of the outer vessel with vacuum pumps. Protons that are absorbed similarly convert into hydrogen gas and are also removed via the same pumps. On the other hand, the boron-11 nuclei convert back to boron metal. In the absence of oxygen, the absorbed boron eventually coats the material from which the mesh is comprised.

There is one important fact that distinguishes the beam particles from the alpha particles. Whereas the kinetic energy distribution as seen in FIG. 5 is very broad, the kinetic energy distributions of both the boron-11 nuclei and the protons are very narrow. In fact, the radial extent of the Coulomb-scattered trajectories corresponds very closely to the radii of the mesh spheres. Ideally, the outer mesh electrode [010] would recover all of the protons with little or no energy penalty, and the inner mesh electrode [008] would recover all of the boron-11 nuclei. This latter situation is automatically true since the boron-11 nuclei have insufficient kinetic energy to ever reach the radius of the outer mesh electrode [010]. Therefore, one embodiment is for the outer mesh electrode [010] to have a much higher opacity to protons than the inner mesh electrode [008]. Even better would be an architecture in which the proton opacity of the outer mesh electrode [010] is much higher than the high-energy alpha particle opacity. The sweeping system described in the next section provides this opacity differential.

Sweeping System

At the radius of the outer mesh electrode [010], under the conditions illustrated in FIG. 1, the majority of high-energy alpha particles destined to be absorbed in the outer vacuum vessel wall [004] have kinetic energies between 5 MeV and 1.1 MeV. This upper end number is the maximum alpha particle kinetic energy in FIG. 5 (approximately 5.5 MeV) minus the 0.524 MeV lost be climbing up the potential well created by the negative charge on the inner mesh electrode [008]. The lower limit of 1.1 MeV is the remaining depth of the electrostatic potential well created by the combined charges on both the inner [008] and outer [010] mesh electrodes. At this lower limit the radial velocity of the soon-to-be absorbed alpha particles past the outer mesh electrode [010] is approximately 0.024c, or 7.3 microns/sec.

The low-energy alpha particles have radial velocities between 1.1 MeV and zero. The scattered protons all reach zero radial velocity very near this radius. The amount of time these particles dwell in the vicinity of the outer mesh sphere is determined by the local radial electric field. Therefore, the one thing that differentiates the protons from the high-energy alpha particles at this radius is their radial velocity, and hence dwell time near the outer mesh electrode [010]. This difference is exploited by the sweeping system.

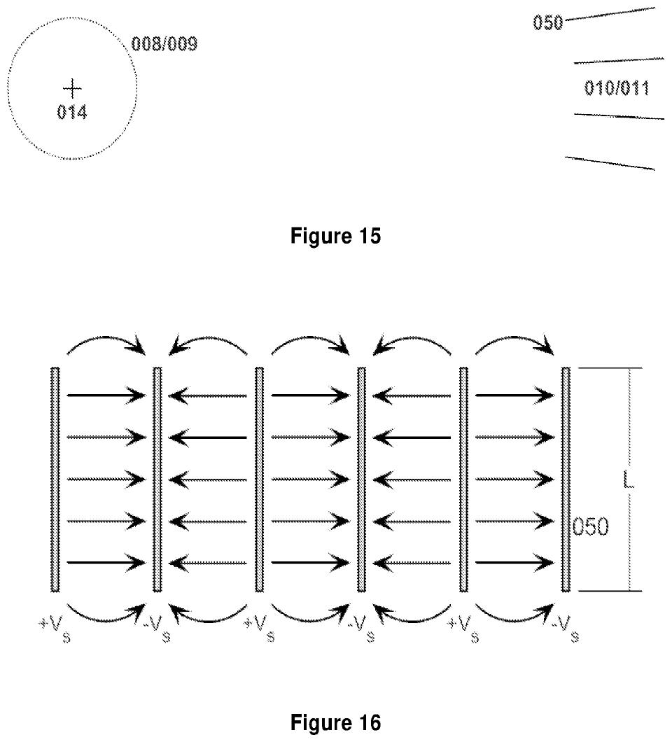

FIG. 15 contains a highly-exaggerated (not to scale) illustration of one proton sweeper embodiment. Instead of the outer mesh electrode [010] being comprised of wires, the mesh is comprised of thin strips [050] whose thickness is comparable to the wires and having a radial length L. These strips [050] are aligned so that the strips [050] point back toward the central region [014]. A high-energy alpha particle will see a material thickness (and hence geometric opacity) unchanged from that of the original wire mesh electrode [010] embodiment.

The next step is to superimpose a differential voltage Vₛ between nearest-neighbor strips [050] as shown in FIG. 16. The protons are drawn to the negatively charged −Vₛ strips [050] (relative to the positively charged strips [050] with the +Vₛ differential voltage). The arrows show the electric field pattern between the strips [050]. In spherical coordinates, the result is an azimuthal electric field that deflects near-stationary protons and low-energy alpha particles into the strips [050] to be absorbed. The magnitude of the differential voltage and the length of the strips [050] are set to achieve a desired proton opacity.

Therefore, in one embodiment of the generator [002] said first spherical mesh electrode [011] is comprised of radially oriented strips [050] with a relative voltage difference between nearest neighbor strips [050]. Another embodiment entails a method wherein said generating carried out with at least one spherical mesh electrode comprised of radially oriented strips [050] with a relative voltage difference between nearest neighbor strips [050].

Electrical Power Transmission: Overview

In Section E the storage of electrical energy in the form of residual electrons at the boron [018] and proton [016] sources were taught. The capacitance between those sources (and associated mesh electrodes [008] and [010]) and the outer vacuum vessel wall [004] allows the storage of electrical energy in the form of electrostatic potential energy. In order for the electrical generator [002] of this instant application to function, electrical energy on the inside of the vacuum vessel wall [004] is coupled to the outside.

Under more conventional circumstances, as in an example of an automotive battery, an output electrical power [082] of 2 kW can be drawn at a variety of voltages and electrical currents. The automotive battery may source 2 kW either as 167 Amperes at 12 V or, with the use of an intermediary voltage inverter, as 16.7 A at 120 V. In this situation, the voltage of the capacitance in recited embodiments is as high as 1600 kV. While electrical vacuum feedthroughs [124] capable of handling voltages as high as 100 kV exist commercially, feedthroughs significantly higher than this voltage are subject to a variety of failure modes. Therefore, several embodiments herein reduce the voltage at which the output electrical power [082] is coupled through the vacuum vessel wall [004]. Power transmission embodiments should also maintain high electrical efficiency, with voltage step down accompanied by an electrical current step up.

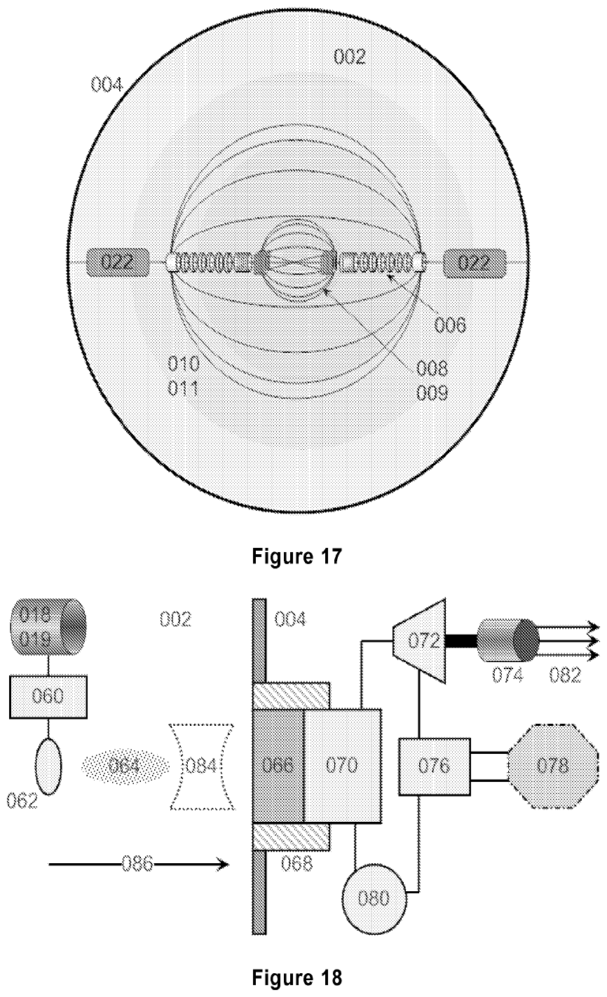

The coupling of internal electrostatic energy to the outside of the generator [002] indicates a conduit [022] for transporting the excess electrons in the proton [016] and boron [018] sources out to the vacuum vessel wall [004]. FIG. 17 is an illustration of one embodiment of the location of such conduits [022]. There are many possible means by which such conduits [022] can transmit electrical current. The followings sections each represent a class of embodiments for output electrical power [082] transmission. Consistent with the embodiment illustrated in FIG. 11 wherein electron transport from the boron ion sources [018] is taught for output electrical power [082] generation and transmission, FIG. 17 shows the conduits [022] between the proton sources [016] and the vacuum vessel wall [004]. In that embodiment an electron transport mechanism is indicated along the ion accelerator [006] structure. An alternative embodiment has the conduit linking the boron sources [018] directly with the vacuum vessel wall [004].

In one embodiment, energy released from the nuclear fusion reactions is not converted into said output electrical power [082] by a means approximated by a Carnot cycle. Another embodiment includes a method of generating wherein the generating is carried out devoid of converting energy released from the nuclear fusion reactions into said output electrical power [082] by a means approximated by a Carnot cycle.

Electrical Power Transmission: Heat

In the embodiment illustrated in FIG. 11 the voltage difference between the boron sources [018] and the vacuum vessel wall [004] is 1590 kV. As illustrated in FIG. 18, the radial electric field [086] associated with this voltage difference can be used to accelerate negatively charged particles [064] toward the vacuum vessel wall [004]. Electrically connected to the boron source [018] is a negative particle emitter [062] via an electrical current regulator [060]. The regulator [060] ensures that the boron source [018] voltage remains unchanged, siphoning off electrons at the rate that electrons accumulate within the source [018]. In an embodiment the generator [002] includes one or more regulators [060] configured to transmit electrons from said source of said second ion beam [019] to said vacuum vessel wall [004] so as to produce the output electrical power [082]. Another embodiment entails a method of generating wherein regulating transmission of electrons remaining from said forming of said second ion beam [019] to said wall [004] to produce said output electrical power [082].

In one embodiment one or more regulators [060] are connected to one or more negative particle emitters [062] emitting negatively charged particles [064]. Another embodiment entails a method of generating wherein regulating is carried out with at least one negative particle emitter [062]. In one embodiment the negatively charged particles [064] are electrons, or more generally, said particles [064] emanating from said one or more negative particle emitters [062] are electrons. A related embodiment entails a method of generating wherein said regulating is carried out with beams of negatively charged particles [064] emanating from said negative particle emitter [062] comprising electrons. In these embodiments the emitter [062] can be a cathode, either a hot filament or a cold cathode.

In another embodiment the negatively charged particles [064] are ions that are otherwise neutral atoms that have an extra electron added (predominantly H₂⁻ and He⁻). Given that hydrogen and helium already exist in the vacuum and need to be transported out of the generator [002], one embodiment uses those gases travelling through a negatively ionizing structure [062]. In one variation of this embodiment the target [066] is comprised of titanium, wherein the target [066] acts identically to the titanium getter plates within an ion-sputter pump [044].

Therefore, one embodiment has a generator [002] in which said particles [064] emanating from said one or more negative particle emitters [062] are negatively charged ions. In one specific embodiment said negatively charged ions [064] are ions of helium. In another specific embodiment said negatively charged ions [064] are ions of hydrogen. Another one embodiment entails a method of generating wherein said regulating is carried out with said particles [064] emanating from said negative particle emitter [062] comprising negatively charged ions. In one specific embodiment said regulating is carried out with said negatively charged ions [064] comprising ions of helium. In another specific embodiment said regulating is carried out with said negatively charged ions [064] comprising ions of hydrogen.

In FIG. 18 the negative particles [064] hit a liquid [070] cooled target [066] that is thermally insulated [068] from the rest of the vacuum vessel wall [004]. The cooling liquid [070] heats up and boils, driving a turbine [072] connected to a conventional electrical generator [074] that transmits the output electrical power [082]. The vapor is condensed in a heat exchanger [076]. In one embodiment said generator [002] is configured to electrostatically accelerate said negatively charged particles [064] into a target [066], cool the target by a circulating cooling liquid [070] which boils the liquid [070] to produce vapor, direct the vapor to drive a turbine [072] connected to an other generator [074] that contributes to said output electrical power [082], and thereafter, cool the vapor with a heat exchanger [076], the generator [002] comprising a pump [080] located to perform the circulating of the liquid [070]. In one specific embodiment said liquid [070] comprises water. In another specific embodiment said target [066] is connected to said vacuum vessel wall [004] via at least one thermal insulator [068]. In an alternative specific embodiment said target [066] is inside said vacuum vessel wall [004], vacuum fluid feedthroughs transmit the said cooling liquid [070] through said vacuum vessel wall [004] to said turbine [072], and said heat exchanger [076] exterior to said vacuum vessel wall [004].

Another embodiment entails a method of generating including electrostatically accelerating particles [064] that emanate from said negative particle emitter [062] into a target [066], cooling said target [066] with a circulating liquid [070] which boils to produce vapor, directing the vapor to drive a turbine [072] connected to an other generator [074] that contributes to said output electrical power [082], and cooling the vapor with a heat exchanger [076]. One specific embodiment entails said circulating liquid [070] comprising water.

In one embodiment the vapor's heat is transferred to an external temperature bath [078] such as water in a lake or river. In another embodiment the external temperature bath [078] is a coil buried underground. A pump [080] returns the liquid [070] back to the target. There can be many variations of this embodiment, though this embodiment and its variations are approximated by a Carnot cycle.

In one embodiment the radial electric field [086] is shaped with intermediate electrodes [084] between the emitter [062] and target [066] so as to focus the negative particle beam [064] onto the target [066]. In one specific focusing embodiment the focusing elements [084] are electrostatic quadrupoles. In another focusing embodiment the intermediate electrostatic electrodes [084] modulate the radial electric field [086] in order to produce a strong focusing lattice. The modulation of an electric field [086] to produce strong focusing is taught in U.S. Pat. No. 9,543,052 filed Oct. 30, 2006 by the inventor in this instant application. U.S. Pat. No. 9,543,052 is incorporated by reference into this instant application.

In another embodiment the radial electric field [086] is unchanged and permanent magnet quadrupoles [084] or solenoids [084] are utilized. In yet another embodiment a combination of radial electric field [086] changes and magnetic elements [084] focus the negative particle beam [064].

Electrical Power Transmission: External Klystron

Instead of using the kinetic energy of an accelerated negatively charged particles [064] to generate heat, another embodiment is to directly convert that kinetic energy into output electrical energy [104] at radiofrequencies or in the microwave band. In this instant application the terms radiofrequency and microwave are considered synonymous, both considered high frequency. There is a class of devices generally called klystrons that perform the function of converting electrical energy stored in a capacitor into high frequency electrical power [104]. For illustration, U.S. Pat. No. 4,949,011 filed Mar. 30, 1989 titled “Klystron with Reduced Length” (incorporated herein by reference) contains in its FIG. 1 a comprehensive numbered drawing of one embodiment of a klystron.

In the case of the fusion generator [002] of FIG. 1 of this instant application the outer vacuum vessel wall [004] and the two spherical mesh electrodes [008] and [010] form a capacitor which store electrical energy in the form of excess electrons on mesh conductors at elevated voltage. In the case of U.S. Pat. No. 4,949,011 the storage capacitor and circuitry to dump electrical current from that capacitor into cathode 12 are not shown or taught.

In U.S. Pat. No. 4,949,011 the anode 18 is at fixed voltage with respect to the remainder of the klystron while the cathode, fixed in its relative position with respect to the anode by dielectric cylinder 16, is raised to a voltage such that the cathode-anode voltage difference times the electron beam current represents the input power of the system.

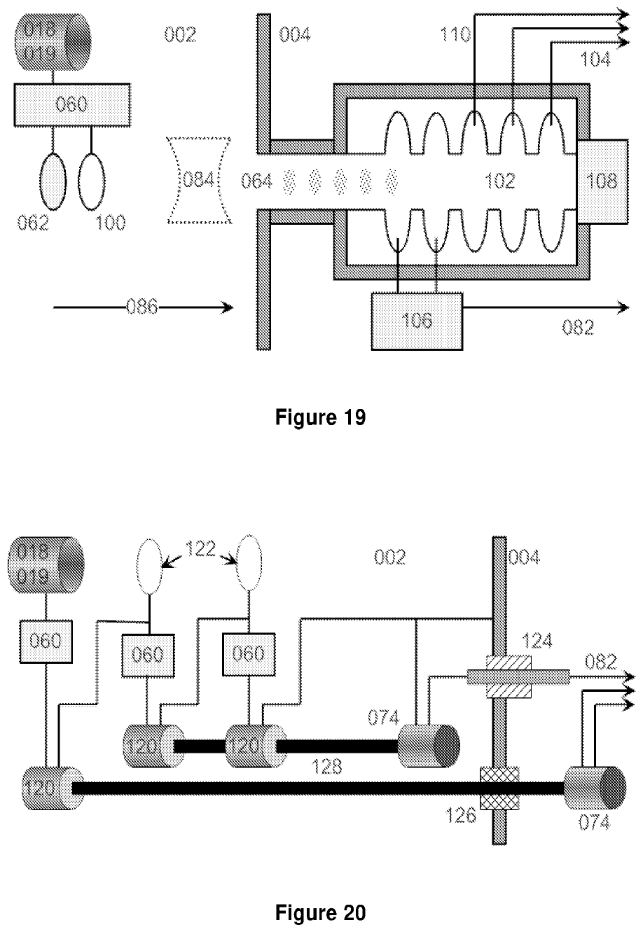

An embodiment of a klystron architecture for transmitting output electrical power [082] or high frequency electrical power [104] from a fusion generator [002] is illustrated in FIG. 19. Electrically connected to the boron source [018] is a negative particle emitter [062] via an electrical current regulator [060]. The regulator [060] ensures that the boron source [018] average voltage remains unchanged, siphoning off electrons at the average rate that electrons accumulate within the source [018]. In one embodiment the siphoning is continuous, while in another embodiment the siphoning occurs in pulses. In the pulsed embodiment the pulse spacing and duration is chosen so as to optimized output electrical power [082] or high frequency power [104] transmission efficiency and maintain boron source [018] voltage within acceptable limits.

In one embodiment said generator [002] is configured to electrostatically accelerate said negatively charged particles [064] into a klystron structure, said klystron structure comprised of one or more radiofrequency cavities [102], wherein for each cavity: said negatively charged particles [064] have velocities modulated by said one or more regulators [060] so as to produce a negative particle electrical current modulation at a frequency matched to said radiofrequency cavity [102] resonant frequency, kinetic energy of said negatively charged particles [064] being converted to high frequency electrical power [104] at the radiofrequency cavity [102] resonant frequency, residual kinetic energy of said negatively charged particles [064] being deposited in a dump [108]; and high frequency electrical power [104] being coupled out of said radiofrequency cavity [102] and presented as output electrical power [082]. Another embodiment includes a method wherein said generating comprises electrostatically accelerating negative particles [064] that emanate from said negative particle emitter [062] into a klystron structure, said klystron structure comprised of one or more radiofrequency cavities [102], wherein for each cavity: modulating velocities of said negative particles [064] by said regulating so as to produce a negative particle electrical current modulation at a frequency matched to a resonant frequency of said radiofrequency cavity [102], converting kinetic energy of said particles [064] to high frequency electrical power [104] at the radiofrequency cavity [102] resonant frequency; dumping residual kinetic energy of said negative particles [064]; and presenting said high frequency electrical power [104] as said output electrical power [082].

In one species embodiment the negatively charged particles [064] are electrons. In this case the emitter [062] can be a cathode, either a hot filament or a cold cathode. In another species embodiment the negatively charged particles [064] are ions that are otherwise neutral atoms that have an extra electron added. Given that hydrogen and helium already exist in the vacuum and need to be transported out of the vessel, one specific species embodiment uses those gases travelling through a negative ionizing structure [062].

Also connected to the regulator is a modulator [100]. In one embodiment the modulator [100] is a fixed-voltage electrostatic structure, while in another embodiment the modulator [100] is a cavity structure similar to the first cavity 34 of U.S. Pat. No. 4,949,011. In the first embodiment the negative beam [064] velocity exiting the modulator [100] is varied by a voltage change of the emitter [062] with respect to the fixed-voltage modulator [100]. A sinusoidal variation of the negative beam [064] velocity results in a temporal negative beam [064] current modulation at the radius of the vacuum vessel wall [004]. In the latter embodiment there is a fixed voltage difference between the emitter [062] and the exterior of the modulator [100], but within the modulator [100] is a cavity structure whose resonant frequency is at or near the modulation frequency. In both embodiments the regulator [060] is responsible for the frequency and amplitude of the modulation voltage applied to the negatively charged beam [064].

By way of a prophetic teaching, the architecture illustrated in FIG. 19 separates the negatively charged particle source [062] and modulation functionality from the high frequency electrical energy harvesting portion (items 40, 42, 44, and 32 in U.S. Pat. No. 4,949,011). The vacuum maintained within the vacuum vessel wall [004] of the fusion generator [002] is shared with the radiofrequency cavities [102], though the waveguides [110] pulling out the high frequency electrical energy contain a dielectric window that isolates the generator vacuum from the atmosphere in the waveguide [110] (as shown in FIG. 1 of U.S. Pat. No. 4,949,011 but not specifically called out by an identifying number). Though not explicitly shown in FIG. 19, in one embodiment the connection between the vacuum vessel wall [004] and the radiofrequency cavities [102] contains vacuum flanges, vacuum gate valves, pumping port(s), vacuum gauges, and other such components can be used when connecting and disconnecting the klystron structure while simultaneously maintaining the vacuum within the vacuum vessel wall [004].

In one embodiment the remaining negative beam [064] kinetic energy that is deposited into the dump [108] (item 32 in U.S. Pat. No. 4,949,011) can be used to boil a cooling liquid [070] as described in Section I. In FIG. 19 a plurality of radiofrequency cavities [102] with multiple waveguides [110] are shown. In one embodiment there is only a single radiofrequency cavity. By way of a prophetic teaching, the high frequency energy harvested from the first two radiofrequency cavities [102] in FIG. 19 is shown entering a rectifier [106] that converts this high frequency electrical energy [104] to a lower frequency that is then output [082] toward a downstream load (not illustrated). By way of another prophetic teaching, the last three radiofrequency cavities [102] show the high frequency electrical energy [104] directly transmitted toward a downstream load (not illustrated).

Electrical Power Transmission: Mechanical

FIG. 20 contains an illustration of an output electrical power [082] transmission architecture in which the excess electrons remaining in the boron source [018] are delivered to the vacuum vessel wall [004] via two or more intermediate electrodes [122]. Consider the electrodes comprising the ion accelerator [006] illustrated in FIG. 2. In FIG. 2 the boron source [018] is at a voltage of −1590 kV, and several intermediate electrodes are shown between the boron source [018] and the proton source [016] at the voltage of −1076 kV. In one embodiment more intermediate electrodes and their respective mechanical supports form the conduits [022] of output electrical power [082] illustrated in FIG. 17.

The transformation of hundreds of kilovolts into a lower voltage/higher electrical current is accomplished in this embodiment in several steps. In each step a regulator [060] sends a current of electrons through an electric motor [120] to an intermediate electrode [122] at another voltage. This voltage difference, times the electron current, represents an electrical power which is converted into rotation mechanical energy by the electric motor [120]. This rotational mechanical energy is transmitted via nonconducting shafts [128] to electrical generators [074]. In one illustrated embodiment there is one electric motor [120] and one electrical generator [074] per nonconducting shaft [128]. In another illustrated embodiment there a plurality of electric motors [120] connected to a common nonconducting shaft [128], said shaft [128] then connected to an electrical generator [074]. In general, an embodiment includes a method of generating within said spherical volume, a voltage gradient having a highest positive voltage at said wall.

In one electrical generator embodiment, the electrical generator [074] is within the generator [002], in proximity to the vacuum vessel wall [004], and the electrical power is transmitted through said wall via an electrical vacuum feedthrough [124]. In this embodiment said one or more regulators [060] are connected to intermediate electrodes [122] between a source of said second ion beam [019] and said vacuum vessel wall [004], said intermediate electrodes [122] at voltages intermediate between a voltage of said source of second ion beam [019] and a voltage of said vacuum vessel wall [004]; said one or more regulators [060] are configured to send electrons from one of said voltages to another of said voltages through one of more electric motors [120]; said one or more electric motors [120] each turn a nonconducting shaft [128] connected to an other generator [074]; and said other generator [074] contributes to said output electrical power [082]. Another embodiment is directed to a method of generating wherein said generating includes using intermediate voltages within said voltage gradient; said regulating includes transmitting electrons between said intermediate voltages through one of more electric motors [120], each said motor [120]; turning a nonconducting shaft [128] connected to an other generator [074]; said other generator [074] contributing to said output electrical power [082]. In a specific embodiment, said other generator [074] is inside said vacuum vessel wall [004] and said output electrical power [082] is transmitted through said vacuum vessel wall [004] utilizing one or more electrical vacuum feedthroughs [124]. In one specific embodiment, a plurality of said electric motors [120] drives a nonconducting shaft [128].

In another embodiment the nonconducting shaft [128] is connected to an electrical generator [074] outside of the vacuum vessel wall [004] by means of a vacuum rotary feedthrough [126]. In other words, the embodiment entails a generator [002] wherein the nonconducting shaft [128] extends through said vacuum vessel wall [004] utilizing a rotary vacuum feedthrough [126]. A rotary feedthrough [126] may utilize a ferrofluidic vacuum seal, a magnetic coupler, or a radial bellows architecture, each of which are commercially available.

In another embodiment illustrated in FIG. 30, the electric motors [120] and nonconducting shafts [128] turn hydraulic pumps [130]. The pumps transmit mechanical motion via the circulation of nonconducting fluids via nonconducting hoses [132] through a hydraulic motor [136] that turns an electrical generator [074] utilizing an other shaft [129]. In such an embodiment, fluids may be coupled through a vacuum vessel wall [004] using fluid vacuum feedthroughs [134]. In other words, this embodiment entails a generator [002] wherein said one or more regulators [060] are connected to intermediate electrodes [122] between a source of said second ion beam [019] and said vacuum vessel wall [004], said intermediate electrodes [122] at voltages intermediate between a voltage of said source of second ion beam [019] and a voltage of said vacuum vessel wall [004]; said one or more regulators [060] are configured to send electrons from one of said voltages to another of said voltages through one of more electric motors [120]; each of said electric motors [120] connected via a shaft to a hydraulic pump [130]; each of said hydraulic pumps [130] delivering a flowing fluid to one or more hydraulic motors [136] via hoses [132], said hydraulic motors [136] each connected to an other electrical generator [074] via an other shaft [128]; and said other generator [074] contributes to said output electrical power [082]. In one embodiment, said flowing fluid is carried in one or more hoses [132] that extend through said vacuum vessel wall [004] via one or more vacuum feedthroughs [134]. In another embodiment, some of said flowing fluid is carried from a plurality of said hydraulic pumps [130] in a single hose [132] that extend through said vacuum vessel wall [004] via one or more vacuum feedthroughs [134]. In another embodiment, said other generator [074] is inside said vacuum vessel wall [004] and said output electrical power [082] is transmitted through said vacuum vessel wall [004] utilizing one or more electrical vacuum feedthroughs [124]. An alternative embodiment entails a method of generating wherein said generating includes generating using intermediate voltages within said voltage gradient; and said regulating transmits electrons between said intermediate voltages through one of more electric motors [120], each said motor [120]: turning a shaft [128] connected to a hydraulic pump [130]; delivering flowing fluid from each said hydraulic pump [130] to one or more hydraulic motors [136], said hydraulic motors [136] each turning an other shaft [128] connected to an other generator [074]; and said other generators [074] contributing to said output electrical power [[082].

In yet other embodiments, the nonconducting shafts [128] are replaced with other means of mechanical energy translation, including pneumatic hoses, piston linkages, or any method of transmitting vibrational energy. For example, the electric motors [120] and electrical generators [074] are replaced by piezoelectric transducers, and the nonconducting shaft [128] is replaced by a material which efficiently transmits ultrasonic waves.

Electrical Power Transmission: Photons

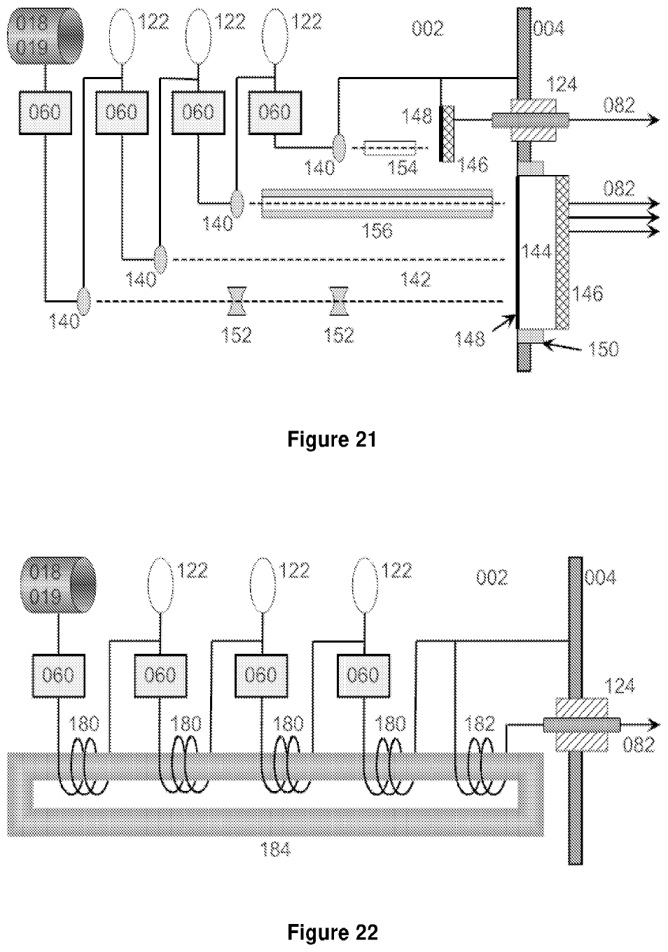

By way of a prophetic teaching, the transmission of energy to the exterior of the fusion generator [002] can be accomplished by using photons [142] to carry that energy across the voltage gradient within the generator [002]. FIG. 21 contains an illustration of one embodiment of such an architecture.

As in the case of mechanical transmission, the generation of photons occurs in several steps utilizing intermediate electrodes [122] at different voltages. In each step, a regulator [060] sends a current of electrons though a photon source [140] to an intermediate electrode [122] at another voltage. This voltage difference, times the electron current, represents an electrical power which is converted into a beam of photons [142] by the photon source [140]. In general the photon source [140] can be any mechanism by which electrical energy is converted into photonic energy. The photon source may be an incandescent filament, a light emitting diode, a laser, or any other mechanism by which electrical current is converted into electromagnetic energy. The plurality of regulators [060] ensures that the boron source [018] and intermediate electrode [122] voltages remains unchanged, siphoning off electrons at the rate that electrons accumulate within the source [018].

In one embodiment entails a generator [002] wherein said one or more regulators [060] are connected to intermediate electrodes [122] between a source of said second ion beam [019] and said vacuum vessel wall [004], said intermediate electrodes [122] at voltages intermediate between a voltage of said source of second ion beam [019] and a voltage of said vacuum vessel wall [004]; said one or more regulators [060] are configured to send electrons from one of said voltages to another of said voltages through one of more photon sources [140]; each of the one or more photon sources [140] delivering photons [142] to one or more photonic receivers [146]; and said photonic receivers [146] contribute to said output electrical power [082]. Another embodiment entails a method of generating wherein said generating includes using intermediate voltages within said voltage gradient; said regulating transmits electrons between said intermediate voltages through one of more photon sources [140], each photon source [140]: delivering photons [142] to at least one photonic receiver [146]; and said at least one photonic receiver [146] contributing to said output electrical power [082].

In one embodiment the photon source [140] is a laser which is aimed at a photonic receiver [146] in proximity to the vacuum vessel wall [004]. While it is possible for the photonic receiver [146] to be within the generator [002] vacuum, the bombardment by alpha particles will eventually degrade some embodiments of such a receiver [146], such as a photovoltaic semiconductor. In FIG. 21 the photonic receiver [146] is shown on the exterior of the generator, wherein the beam of photons is transmitted through the vacuum vessel wall [004] via a window [144] that is transparent to the wavelengths emitted by the photon source [140]. Candidate windows are commercially available already mounted to vacuum flanges [150]. Therefore, in one embodiment the photons [142] are delivered through said vacuum vessel wall [004] via one or more transparent windows [144] mounted into said wall [004].

Because of the flux of high-energy alpha particles striking the vacuum vessel wall [004], in one prophetic teaching the window [144] is thick enough to absorb all of the alpha particles before the alpha particles can reach the photonic receiver [146]. Depending on the size of the window [144], one embodiment includes a coating [148] on the inside surface of the window [144], an electrically conductive coating [148] such as indium tin oxide (ITO). ITO is transparent in the visible and infrared spectrum where the emission spectra of high efficiency LEDs reside. This is the spectral region where high efficiency photovoltaic receivers [146] have peak responses matched to such LEDs. The ITO coating [148] helps deliver electrons to the alpha particles so that neutral atomic helium gas may be generated. Because most of the high-energy alpha particles (helium nuclei) that strike this window [144] have already been decelerated to kinetic energies below 1 MeV, the calculated range of the vast majority of the incident alpha particles will be less than 5 microns. Without such coatings [148], it is possible for electrostatic forces to build up within the window material and cause the window to crack. In a specific embodiment each of said windows [144] has a transparent conductive coating [148] on a surface facing inside of said vacuum vessel.

Between the photon source [140] and the photonic receiver [146] there may be one or more focusing elements [152] to ensure that most or all of the photons [142] strike the photovoltaic receiver [146]. In this embodiment said photons [142] are delivered by passing said photons [142] through intermediate optics [152] between said photon sources [140] and said photonic receivers [146]. Another the embodiment entails a method of generating wherein said delivering includes delivering using intermediate optics [152] between said one or more photon sources [140] and said at least one photonic receiver [146].

In another embodiment the photon source [140] is one or more light emitting diodes (LEDs) that couple the stream of photons [142] to the photonic receiver [146] using an optical waveguide [156]. In other words, said photons [142] are delivered by passing said photons [142] through one or more optical waveguides [156] between said photon sources [140] and said photonic receivers [146]. Another embodiment entails a method of generating wherein said delivering includes delivering using one or more optical waveguides [156] between said one or more photon sources [140] and said at least one photonic receiver [146].

In one embodiment the optical waveguide is one or more optical fibers [154]. In other words, said photons [142] are delivered by passing said photons [142] through one or more optical fibers [154] between said photon sources [140] and said photonic receivers [146]. Another embodiment entails a method of generating wherein said delivering includes delivering said photons [142] by passing said photons [142] through one or more optical fibers [154] between said one or more photon sources [140] and said at least one photonic receivers [146].

In another embodiment, due to possible radiation damage to the quartz of which optical fibers [154] are comprised, the optical waveguide [156] is an optical fiber [154] which is hollow. In other words, said photons [142] are delivered by passing said photons [142] through one or more hollow optical fibers [154] between said photon sources [140] and said photonic receivers [146]. Another embodiment entails a method of generating wherein said delivering includes delivering said photons [142] by passing said photons [142] through one or more hollow optical fibers [154] between said one or more photon sources [140] and said at least one photonic receivers [146].

In a specific embodiment teaches a generator [002] wherein one or more of said photonic receivers [146] are inside said vacuum vessel, and said output electrical power [082] is transmitted through said wall [004] via one or more electrical vacuum feedthroughs [124]. More specifically, in one embodiment wherein one or more of said photonic receivers [148] are inside said vacuum vessel, for each of said photonic receiver [146] a transparent conductive coating [148] is on a surface responsive to photons [142]. In another such embodiment wherein one or more of said photonic receivers [148] are inside said vacuum vessel, at least one of said photonic receivers [146] are shielded from radiation generated within said generator [002].

Electrical Power Transmission: Magnetic Transformer

FIG. 22 contains an illustration of an insulating ferrite core [184] transmitting magnetic flux generated by individual primary coils [180] placed between intermediate electrodes [122]. The changing magnetic flux induces electrical current in a secondary winding [182] in a manner similar to that of a conventional electrical transformer. The lower voltage/higher electrical current output electrical power [082] is then transmitted through the vacuum vessel wall [004] via an electrical vacuum feedthrough [124].

Each regulator circuit [060] passes pulses of electrons from the boron source [018] or another intermediate electrode [122] to another electrode [122] between the boron source [018] and the vacuum vessel wall [004]. The regulator [060] employs a waveform that maximizes the efficiency of output electrical power [082] transmission. In one embodiment the pulses of electrons through each regulator [060] occur simultaneously, while in another embodiment the pulses are timed to be separate from the pulses of other regulators [060]. By way of a prophetic teaching, if there are 100 regulators [060] and the secondary coil [182] sees pulses of magnetic flux occurring at a 60 Hz rate, then each regulator [060] would emit an electron pulse at a repetition rate of 0.6 Hz.

In one embodiment, said one or more regulators [060] are connected to intermediate electrodes [122] between a source of said second ion beam [019] and said vacuum vessel wall [004], said intermediate electrodes [122] at voltages intermediate between a voltage of said source of second ion beam [019] and a voltage of said vacuum vessel wall [004]; said one or more regulators [060] are configured to send electrons from one of said voltages to another of said voltages through one of more primary windings [180] wrapped around one or more insulating ferrite cores [184], wherein for each ferrite core [184] one or more secondary windings [182] are wrapped around said ferrite core [184]; and said secondary windings [182] contribute to said output electrical power [082]. In a specific embodiment, said output electrical power [082] from said secondary windings [182] is transmitted through said vacuum vessel wall [004] via one or more electrical vacuum feedthroughs [124]. Another embodiment includes a method of generating wherein said generating includes generating using intermediate voltages within said voltage gradient; and said regulating transmits electrons between said intermediate voltages through one of more primary windings [180], each primary winding [180]: inducing magnetic flux; delivering said magnetic flux to one or more secondary windings [182]; and said secondary windings [182] contributing to said output electrical power [082].

Secondary Electron Emission

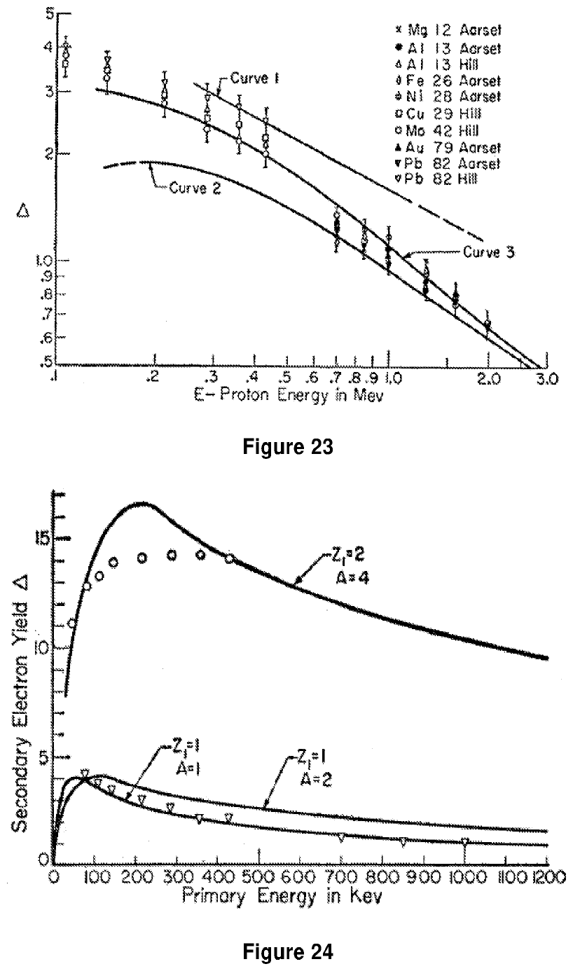

When electrons or ions of sufficient kinetic energy bombard a metallic surface, secondary electron emission is observed. The ratio of observed secondary electrons per incident electron or ion, termed secondary electron yield □, is a function of kinetic energy, ion charge, ion mass, and the composition of the material undergoing bombardment. In the case of hydrogen ions on a variety of metal surfaces, FIG. 23 shows the proton kinetic energy dependence of the secondary electron yield. This data was presented in the paper “Theory of Secondary Electron Emission by High-Speed Ions” by E. J. Sternglass published in Physical Review, volume 108, issue no. 1, pages 1-12 on Oct. 1, 1957. The data plotted in FIG. 24 for helium bombardment was also presented in this same paper that is incorporated by reference.

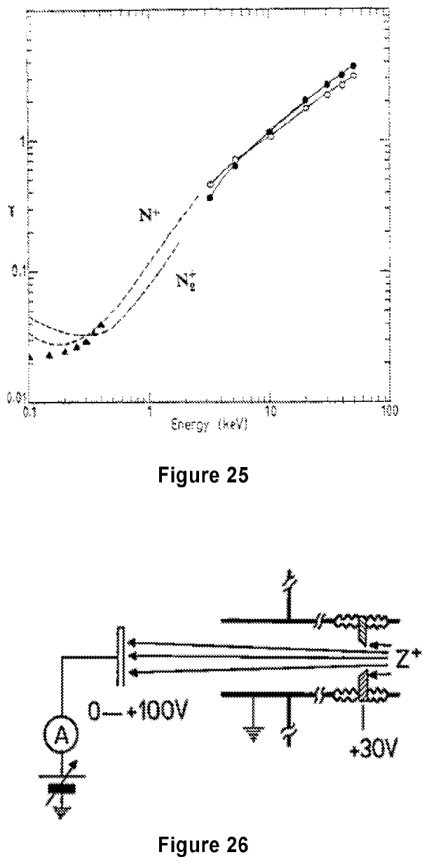

Hydrogen ions (protons) and helium ions (alpha particles) are the two species of ions that will bombard the outer mesh electrode [010] in FIG. 1, while the alpha particles will strike the generator vacuum vessel wall [004]. In addition to those ions, scattered boron ions will also bombard the inner mesh electrode [008]. Data relevant to heavier ions and lower kinetic energies is graphed in FIG. 25, and was taken from the paper “Electron Emission from Molybdenum Under Ion Bombardment” by J. Ferron et. al. published in Journal of Physics D: Applied Physics, volume 14, pages 1707-20 in 1981. FIG. 25 shows the secondary electron yield of molybdenum undergoing bombardment by atomic and molecular nitrogen, with boron ions of comparable energy expected to have a very similar effect. This paper is incorporated herein by reference.

In one embodiment, the vacuum vessel wall [004] of the generator [002] is comprised, or is consisting essentially, of stainless steel. In another embodiment, the vacuum vessel wall [004] is comprised, or is consisting essentially, of titanium. In yet another embodiment, the vacuum vessel wall [004] is comprised, or is consisting essentially, of aluminum.

In one embodiment a coating is placed on the inside surface of the vacuum vessel wall [004] to inhibit secondary electrons, secondary ions, or both. In another embodiment a coating is placed on the inside surface of the vacuum vessel wall [004] to inhibit desorption of gas, inhibit outgassing due to ion bombardment, and/or to improve vacuum by providing a getter surface.

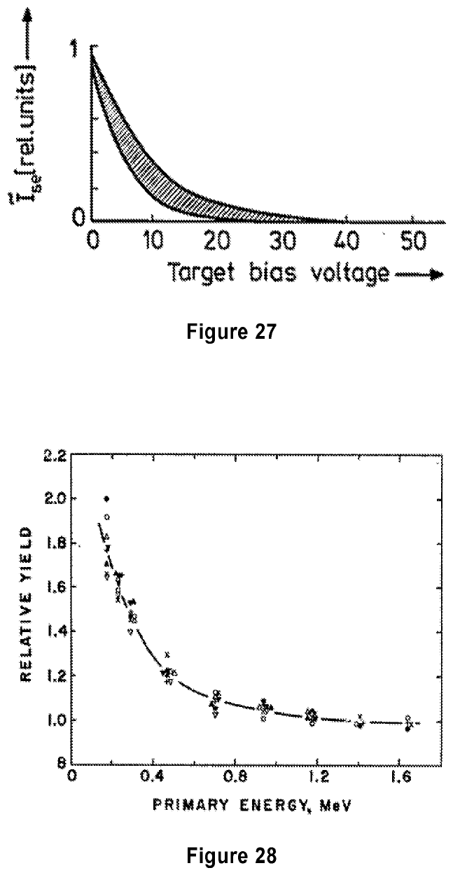

When alpha particles strike the vacuum vessel wall [004], secondary electrons are generated as expected given the data in FIG. 24. The kinetic energy spectrum of the secondary electrons is less than 100 eV, as indicated from previous measurements such as those shown in FIG. 27. The data in FIG. 27 and the illustration in FIG. 26 were taken from the paper “Secondary Electron Yields from Clean Polycrystalline Metal Surfaces Bombarded by 5-20 keV Hydrogen or Noble Gas Ions” by P. C. Zalm and L. J. Beckers published in the Phillips Journal of Research, volume 39, pages 61-76 in 1984. This paper is incorporated herein by reference.

The apparatus illustrated in FIG. 26 was used to measure the kinetic energy distribution. The electric field between the ion source to the right and the surface emitting secondary electrons on the left will turn around the lower energy electrons before the secondary electrons are lost on the grounded ion source tube. The higher the voltage creating this electric field, the smaller the measured electron current will become. At some voltage no secondary electrons will have sufficient kinetic energy to reach the ion source tube.

The data graphed in FIG. 27 shows this trend. Note that when a voltage of 40 V is imposed, no secondary electron current is observed. This means that the maximum kinetic energy of the secondary electrons is approximately 40 electron volts.

The geometry of the generator [002] of this instant application is functionally analogous to the apparatus in FIG. 26. The negative voltage of the mesh electrodes [008] and [010] create an electric field that pushes any secondary electrons emitted from the generator vacuum vessel wall [004] back into the wall [004]. For the embodiment illustrated in FIGS. 1, 2, and 11 a secondary electron would need to have a kinetic energy of greater than 1076 keV in order to reach the outer mesh electrode [010]. Measured secondary electron kinetic energies are far smaller than this value. Therefore secondary electron emission from the vacuum wall [004] has no effect on generator [002] operations.

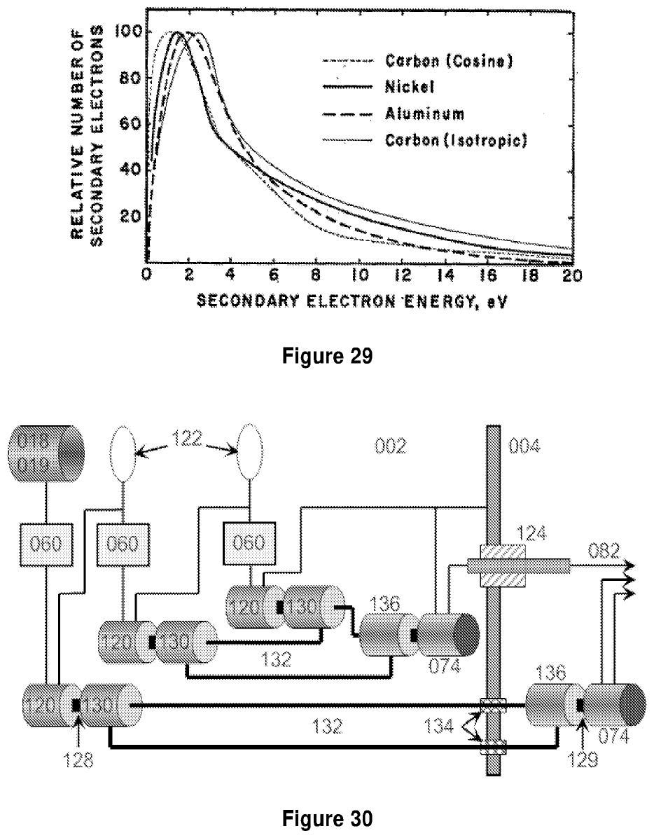

When protons and alpha particles strike the outer mesh electrode [010], the secondary electrons see an accelerating radial electric field [086] toward the outer vacuum wall [004]. Even secondary electrons which are created with a kinetic energy infinitesimally small are accelerated to 1 MeV by the time the secondary electrons bombard the vacuum vessel wall [004]. FIGS. 28 and 29 contain data presented in the paper “Secondary Electron Emission Produced by Relativistic Primary Electrons” by A. A. Schultz and M. A. Pomerantz published in The Physical Review, volume 130, issue no. 6, pages 2135-41 on Jun. 15, 1963. This paper is incorporated herein by reference.

FIG. 28 shows that there is on average at least one secondary electron, and as many as two secondary electrons, for every electron that strikes a metal surface at kinetic energies of 1.6 MeV and below. FIG. 29 is a graph of kinetic energy spectrum of those secondary electrons. As in the case of secondary electrons liberated through ion bombardment, secondary electrons emitted due to high-energy electron bombardment is also relatively small, again less than 40 eV.

The data in FIGS. 28 and 29 again indicate that secondary electrons emitted from the generator vacuum vessel wall [004] are not energetic enough to reach the outer mesh electrode [010]. Therefore secondary electron emission from the outer vacuum vessel wall [004] again has no effect on generator [002] operations.

On the other hand, these secondary electrons emanating from the outer mesh electrode [010] and transported to the vacuum vessel wall [004] represent an electrical power drain, or partial short circuit. In FIG. 11 it is shown that 25.6% of the alpha particles are absorbed by the outer mesh electrode [010], which corresponds to an average of 0.77 alpha particles per fusion event (three alpha particles are generated in each fusion event). In that embodiment the absorption of the low-energy alpha particles actually increases the output power of the generator by 0.2%. According to FIG. 24 there can be as many as 14 secondary electrons generated per absorbed alpha particle. For an average fusion event this worst-case number of secondary electrons would cause 10.8 secondary electrons to accelerate toward the vacuum vessel wall [004], when the fusion event itself only liberates a combined total of 6 electrons. This set of facts would predict that such a fusion generator embodiment cannot generate net positive output electrical power [082].

One method of suppression of secondary electron emission include increased surface roughness, locally-shaped electric fields, imposition of magnetic fields, and coatings. For coatings, surface coatings such as carbon and titanium nitride are specifically indicated.

In one embodiment the electrodes forming the outer mesh electrode [010] are metal coated with a carbon coating, the carbon being in the form a diamond, graphite, carbon nitride, or some other carbon-containing compound. In this embodiment the first spherical mesh electrode [011] is coated with a carbon compound. In another embodiment said second spherical mesh electrode [009] is coated with a carbon compound. An alternative embodiment entails a method wherein said generating is carried out with at least one spherical mesh electrode coated with a carbon compound. Carbon can be used to suppress secondary electron emission yield by a factor of five. In another embodiment the electrodes forming the outer mesh electrode [010] are comprised of carbon fibers bound together into a composite structure. In another embodiment the electrodes forming the outer mesh electrode [010] have a surface which has been roughened or structured in such a way to minimize secondary electron emission. In another embodiment the structural members forming the outer mesh electrode [010] are shaped in order to minimize secondary electron emission. In another embodiment the structural members forming the outer mesh electrode [010] have a permanent magnetization of sufficient shape and magnitude to minimize secondary electron emission yield. In another embodiment a magnetic field is generated in close proximity of the outer mesh electrode [010] surfaces by running electrical current through them. In another embodiment a plurality of surface roughness, coatings, locally-shaped electric fields, and magnetic fields are used together to minimize secondary electron yield.

FIG. 11 also teaches that 14.4% of the alpha particles do not have enough kinetic energy to reach the outer mesh electrode [010] and are absorbed exclusively by the inner mesh electrode [008]. The scattered boron ions are also exclusively absorbed by the inner mesh electrode [008].

At the radius of the inner mesh electrode [008] the scattered boron ions have a radial kinetic energy of 50 keV. Even though the embodiment illustrated in FIG. 11 has the outer mesh electrode [010] with a much higher opacity than the inner mesh electrode [008], in an embodiment in which the inner mesh electrode [008] is comprised of wires all of the boron ions will strike those wires at 50 keV. According to the data in FIG. 25, approximately two secondary electrons will be generated for every absorbed boron ion. This will also cause a partial short circuit and compromise the performance of the generator.

Using the same sweeper technology illustrated in FIG. 16, most of the boron ions will be absorbed by the inner mesh electrode [008] with a much smaller azimuthal kinetic energy, reducing the secondary emission yield to less than 0.1 secondary electrons per absorbed boron ion.

In the case of the 14.4% of the alpha particles that do not have sufficient kinetic energy to reach the outer mesh electrode [010], the inner electrode [008] will absorb alpha particle of kinetic energy between zero and approximately 1 MeV. According to the data in FIG. 24 alpha particles absorbed with these kinetic energies will liberate as many as 14 secondary electrons. Therefore, the strategies taught for secondary electron yield minimization from the outer mesh electrode [010] will also need to be applied to the inner mesh.

A unique concern with coated inner mesh electrode [008] surfaces is that the surfaces will eventually accumulate enough boron to become effectively boron-coated. In this case secondary electron emission yields will again become a problem. All other surfaces will become coated with helium or hydrogen which will turn to gas and be pumped out.

By way of a prophetic teaching, one method for overcoming the effect for boron coating of the inner mesh electrode [008] is to periodically perform in-situ vapor deposition of carbon or carbon-containing compounds. By way of a prophetic teaching, a method for eliminating the boron coating of the inner mesh is to periodically introduce a solvent designed to remove boron or compounds of boron, such as boric acid. In one embodiment, upon flooding the chamber with a halon gas the boron can be removed via the formation of boron halide compounds which are gasses that can be pumped out. In another embodiment, upon flooding the vacuum chamber with boiling water the boron will convert into boric acid which dissolves into the water, which can then be pumped out.

Statement of Scope

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. An apparatus comprising:
a generator configured to produce output electrical power by bringing two species of ions into collisions that induce nuclear fusion reactions and thereby produce more of said output electrical power than electrical power input to the generator, wherein the generator is devoid of a magnetic field that constrains a plasma comprised of said two species of ions brought into said collisions;
wherein said two species of ions are brought into said collisions as a first ion beam comprised of one of said species of ions and a second ion beam comprised of another of said species of ions, both said first ion beam and said second ion beam consisting essentially of no electrons;
said generator including:
a spherical vacuum vessel containing a vacuum and comprising a vacuum vessel central region and a vacuum vessel wall; and
an electrostatic accelerator structured to direct said first ion beam to repeatedly collide with said second ion beam in said vacuum vessel central region to produce said collisions; wherein:
said generator is configured to:
produce said first ion beam with an average kinetic energy greater than or equal to an average kinetic energy of said second ion beam during said collisions and such that said first ion beam has an average momentum equal to an average momentum of said second ion beam during said collisions, and such that said first ion beam and said second ion beam have a combined kinetic energy sufficient for said nuclear fusion reactions when the two species of ions experience the collisions;
wherein the generator further includes:
a first spherical mesh electrode, concentric with said spherical vacuum vessel, connected to a source of said first ion beam,
a second spherical mesh electrode, concentric with said spherical vacuum vessel, connected via an intermediate power supply to a source of said second ion beam, wherein
said first spherical mesh electrode is configured to have a higher opacity to ions emanating from said collisions than said second spherical mesh electrode; and further comprising one or more regulators configured to transmit electrons from said source of said second ion beam to said vacuum vessel wall so as to produce the output electrical power.

74. The apparatus of claim 73, wherein said first ion beam is comprised of hydrogen and said second ion beam is comprised of boron-11.

75. The apparatus of claim 73, wherein said first spherical mesh electrode is comprised of radially oriented strips with a relative voltage difference between nearest neighbor strips.

76. The apparatus of claim 73, wherein said one or more regulators is connected to one or more negative particle emitters configured to emit negatively charged particles.

77. The apparatus of claim 73, wherein said one or more regulators is connected to one or more negative particle emitters configured to emit electrons.

78. The apparatus of claim 73, wherein said one or more regulators is connected to one or more negative particle emitters configured to emit ions.

79. The apparatus of claim 76, wherein said generator is configured to electrostatically accelerate said negatively charged particles into a target, to cool the target by circulating a liquid that boils to produce vapor, and to direct the vapor to drive a turbine connected to an other generator connected so as to contribute to said output electrical power, and thereafter, to cool the vapor with a heat exchanger, the generator comprising a pump located to perform the circulating of the liquid.

80. The apparatus of claim 73, wherein said ions are brought into said collisions in said vacuum that is maintained by one or more ion-sputter pumps.

81. The apparatus of claim 76, wherein said generator is configured to electrostatically accelerate said negatively charged particles into a klystron structure comprised of one or more radiofrequency cavities, wherein for each said radiofrequency cavity:
said negatively charged particles have velocities modulated by said one or more regulators so as to produce a negative particle electrical current modulation at a frequency matched to a resonant frequency of said radiofrequency cavity,
kinetic energy of said negatively charged particles is converted to high frequency electrical power at the resonant frequency,
residual kinetic energy of said negatively charged particles is deposited in a dump; and
high frequency electrical power is coupled out of said radiofrequency cavity and presented as said output electrical power.

82. The apparatus of claim 73, wherein:
said one or more regulators are connected to intermediate electrodes between a source of said second ion beam and said vacuum vessel wall, said intermediate electrodes presenting voltages intermediate a voltage of said source of said second ion beam and a voltage of said vacuum vessel wall;
said one or more regulators are configured to send electrons from one of said voltages to an other of said voltages through one or more electric motors;
said one or more electric motors each turn a nonconducting shaft connected to an other generator; and
said other generator contributes to said output electrical power.

83. The apparatus of claim 73, wherein:
said one or more regulators are connected to intermediate electrodes, said one or more regulators and said intermediate electrodes located between a source of said second ion beam and said vacuum vessel wall, said intermediate electrodes at voltages intermediate to a voltage of said source of said second ion beam and a voltage of said vacuum vessel wall;
said one or more regulators are configured to send electrons from one of said voltages to another of said voltages through one of more photon sources;
each of the one or more photon sources located to deliver photons to one or more photonic receivers; and
said photonic receivers contribute to said output electrical power.

84. The apparatus of claim 73, wherein:
said one or more regulators are connected to intermediate electrodes between a source of said second ion beam and said vacuum vessel wall, said intermediate electrodes at voltages intermediate a voltage of said source of said second ion beam and a voltage of said vacuum vessel wall;
said one or more regulators are configured to send electrons from one of said voltages to another of said voltages through one or more electric motors;
each of said one or more electric motors connected via a shaft to a hydraulic pump;
each of said hydraulic pump delivering a flowing fluid to one or more hydraulic motors via hoses, said hydraulic motors each connected to an other electrical generator via another shaft; and
said other electrical generator contributes to said output electrical power.

85. The apparatus of claim 73, wherein:
said one or more regulators are connected to intermediate electrodes between a source of said second ion beam and said vacuum vessel wall, said intermediate electrodes at voltages intermediate a voltage of said source of said second ion beam and a voltage of said vacuum vessel wall;
said one or more regulators are configured to send electrons from one of said voltages to another of said voltages through one of more primary windings wrapped around one or more insulating ferrite cores, wherein for each one of the ferrite cores, one or more secondary windings are wrapped around said one of the ferrite cores; and
said secondary windings contribute to said output electrical power.

86. A method of generating electrical power, the method comprising:
generating more output electrical power than electrical power input to an apparatus by bringing two species of ions into collisions that induce nuclear fusion reactions, wherein the bringing into collision is carried out devoid of constraining a plasma with a magnetic field;
wherein the bringing the two species of ions into collisions comprises bringing into said collisions one of said species of ions as a first ion beam and a second of said species of ions as a second ion beam, both said first ion beam and said second ion beam consisting essentially of no electrons;
and further including:
evacuating a spherical volume, within a wall, to produce a vacuum sufficient to enable storage of said ion beams;
forming said first ion beam within the volume;
forming said second ion beam within the volume;
electrostatically accelerating, within said spherical volume, said first ion beam to repeatedly collide with said second ion beam in a central region of said spherical volume to produce said collisions, said first ion beam having an average kinetic energy greater than or equal to an average kinetic energy of said second ion beam during said collisions, said first ion beam having an average momentum equal to an average momentum of said second ion beam during said collisions, and said first and second ion beams having a combined kinetic energy sufficient to induce the nuclear fusion reactions when the ions within each beam experience said collisions;
generating, within said spherical volume, a voltage gradient having a highest positive voltage at said wall;
regulating transmission of electrons remaining from said forming of said second ion beam to said wall to produce said output electrical power.

87. The method of claim 86, wherein the forming of the first ion beam includes forming of the first ion beam is carried out with the ions comprising hydrogen and the forming of the second ion beam is carried out with the ions comprising boron-11.

88. The method of claim 86, wherein said evacuating includes evacuating with an ion sputter vacuum pump.

89. The method of claim 86, wherein said generating carried out with at least one spherical mesh electrode comprised of radially oriented strips with a relative voltage difference between nearest neighbor strips.

90. The method of claim 86, wherein said regulating is carried out with at least one negative particle emitter emitting negatively charged particles.

91. The method of claim 90, wherein said regulating is carried out with beams of negatively charged particles comprising electrons.

92. The method of claim 90, wherein said generating includes:
electrostatically accelerating particles that emanate from said at least one negative particle emitter into a target;
cooling said target with a circulating liquid which boils to produce vapor;
directing the vapor to drive a turbine connected to an other generator that contributes to said output electrical power; and
cooling the vapor with a heat exchanger.

93. The method of claim 90, wherein said generating comprises:
electrostatically accelerating negative particles that emanate from said at least one negative particle emitter into a klystron structure, said klystron structure comprised of one or more radiofrequency cavities, wherein for each cavity:
modulating velocities of said negative particles by said regulating so as to produce a negative particle electrical current modulation at a frequency matched to a resonant frequency of said radiofrequency cavity,
converting kinetic energy of said particles to high frequency electrical power at the resonant frequency; and
dumping residual kinetic energy of said negative particles; and
presenting said high frequency electrical power as said output electrical power.

94. The method of claim 86, wherein:
said generating includes using intermediate voltages within said voltage gradient;
said regulating includes transmitting electrons between said intermediate voltages through one or more electric motors, each said motor, turning a nonconducting shaft connected to an other generator; and
contributing to said output electrical power with said other generator.

95. The method of claim 86, wherein:
said generating includes using intermediate voltages within said voltage gradient;
said regulating transmits electrons between said intermediate voltages through one of more photon sources, each photon source:
delivering photons to at least one photonic receiver; and
contributing to said output electrical power with said at least one photonic receiver.

96. The method of claim 86, wherein:
said generating includes generating by using intermediate voltages within said voltage gradient; and
said regulating transmits electrons between said intermediate voltages through one of more electric motors, each said motor:
turning a shaft connected to at least one hydraulic pump; and
delivering flowing fluid from each said hydraulic pump to one or more hydraulic motors, each of said hydraulic motors turning an other shaft connected to an other generator; and
contributing to said output electrical power with said other generator.

97. The method of claim 86, wherein:
said generating includes generating using intermediate voltages within said voltage gradient; and
said regulating transmits electrons between said intermediate voltages through one of more primary windings, each primary winding:
inducing magnetic flux;
delivering said magnetic flux to one or more secondary windings; and
contributing to said output electrical power with said secondary windings.
